(19) United States
(12) Patent Application Publication
(10) Pub. No.: US 2016/0209685 A1
(43) Pub. Date: Jul. 21, 2016

(54) LIQUID CRYSTAL DEVICE, METHOD OF DRIVING LIQUID CRYSTAL DEVICE, AND ELECTRONIC APPARATUS

(71) Applicant: SEIKO EPSON CORPORATION, Tokyo (JP)

(72) Inventors: Naoki TOMIKAWA, Fujimi-machi (JP); Tomoki YOKOTA, Suwa-shi (JP)

(73) Assignee: SEIKO EPSON CORPORATION, Tokyo (JP)

(21) Appl. No.: 14/990,294

(22) Filed: Jan. 7, 2016

(30) Foreign Application Priority Data
Jan. 20, 2015 (JP) 2015-008355

(51) Int. Cl. G02F 1/137; G02F 1/1339; G02F 1/1343; G02F 1/1337

(52) U.S. Cl. CPC G02F 1/137; G02F 1/1337; G02F 1/1339; G02F 1/134309; G02F 2001/133742; G02F 2001/13712

(57) ABSTRACT

A liquid crystal device includes a pixel electrode, a peripheral electrode that is arranged between an outer edge of a display region in which the pixel electrode is arranged and a sealing material, a control electrode that is arranged between the outer edge of the display region and the peripheral electrode, a common electrode that is provided on a facing substrate, and an orientation film that substantially vertically orients liquid crystal molecules in a liquid crystal layer on the control electrode. In a display period during which the pixel electrode is driven, a potential that is lower than a potential of the common electrode is supplied to the peripheral electrode, and an AC potential with reference to the potential of the common electrode is supplied to the control electrode. In a non-display period during which the pixel electrode is not driven, no potential is supplied to the control electrode.

### BACKGROUND

1. Technical Field

The present invention relates to a liquid crystal device, a method of driving a liquid crystal device, and an electronic apparatus.

2. Related Art

A liquid crystal device includes a liquid crystal panel with a liquid crystal layer interposed between a pair of substrates. If light is incident on such a liquid crystal panel, there may be a case in which a liquid crystal material, an orientation film, and the like that form the liquid crystal panel cause a photochemical reaction due to the incident light and ionic impurities are generated as a reaction product. In addition, it has been known that there are ionic impurities that are diffused in the liquid crystal layer from a sealing material, a shielding material, or the like in the course of manufacturing the liquid crystal panel. In a liquid crystal device used as a light modulation structure (light valve) in a projection-type display apparatus (projector), in particular, light flux density of the incident light is higher than that of a direct view-type liquid crystal device. Therefore, it is necessary to suppress an influence of the ionic impurities on display.

For example, JP-A-2007-279172 discloses a liquid crystal display device including a pixel region electrode provided in a pixel region and a peripheral regain electrode provide in a peripheral region, in which a value of a drive voltage applied to the peripheral region electrode is greater than a value of a drive voltage applied to the pixel region electrode. According to the liquid crystal display device disclosed in JP-A-2007-279172, it is possible to move ionic impurities mixed into the liquid crystal layer from the pixel region to the peripheral region and to reduce the influence of the ionic impurities on display.

For example, JP-A-2007-316119 discloses a liquid crystal display device including an electronic parting region in a substantially ring shape in a periphery of a display region, in which a predetermined drive voltage as an AC voltage for sweeping ions in the liquid crystal is applied to an electronic parting solid electrode provided in an electronic parting region for a predetermined period of time in a non-display operation mode in which no image is displayed in the display region. In addition, the predetermined period of time during which the aforementioned AC voltage is applied to the electronic parting solid electrode is set to be about 30 minutes to about 3 hours.

For example, JP-A-2012-220911 discloses a liquid crystal device including a first peripheral electrode that is provided in a region interposed between an image display region on an element substrate and a sealing material and is supplied with a first drive signal, a second peripheral electrode that is provided in a region, at which the second peripheral electrode faces the first peripheral electrode, on a facing substrate that faces the element substrate and is supplied with a second driving signal configured such that a higher potential and a lower potential than a predetermined potential are alternately repeated, and a third peripheral electrode that is supplied with a third drive signal that varies with a potential difference from the second drive signal. According to JP-A-2012-220911, an electric field in a thickness direction of a liquid crystal layer is generated between the first peripheral electrode and the second peripheral electrode, and an electric field in a traverse direction is generated between the second peripheral electrode and the third peripheral electrode. Therefore, ionic impurities are attracted to each of the first peripheral electrode, the second peripheral electrode, and the third peripheral electrode and are made to stay in the peripheral region.

However, if the ionic impurities in the liquid crystal layer are swept from the display region and are made to stay at the electrodes provided in the peripheral region in JP-A-2007-279172, JP-A-2007-316119, and JP-A-2012-220911, a concentration gradient of the ionic impurities occurs between the display region and the peripheral region. For this reason, there is a concern that the ionic impurities are re-diffused in the display region due to the concentration gradient in a so-called non-driven state in which a potential for sweeping the ionic impurities is not provided to the electrodes in the peripheral region.

### SUMMARY

The invention can be realized as the following aspects or application examples.

### Application Example

According to this application example, there is provided a liquid crystal device including: a liquid crystal layer that is interposed between a pair of substrates arranged so as to face each other via a sealing material; a pixel electrode that is provided on one of the pair of substrates; a peripheral electrode that is arranged between an outer edge of a display region in which the pixel electrode is arranged and the sealing material; a control electrode that is arranged between the outer edge of the display region and the peripheral electrode; a common electrode that is provided in any one of the pair of substrates; and orientation film that substantially vertically orients liquid crystal molecules in the liquid crystal layer on the control electrode, in which in a display period during which the pixel electrode is driven, an AC potential with reference to a potential of the common electrode or a potential that is lower than that of the common electrode is supplied to the peripheral electrode, and an AC potential with reference to the potential of the common electrode is supplied to the control electrode, and in which in a non-display period during which the pixel electrode is not driven, no potential is supplied to the control electrode.

According to the application example, ionic impurities are attracted from the display region toward the peripheral electrode in the display period even if the ionic impurities are included in the liquid crystal layer. In addition, since no potential is supplied to the control electrode in the non-display period during which the pixel electrode is not driven, the liquid crystal molecules in the liquid crystal layer on the control electrode are substantially vertically oriented. Therefore, the substantially vertically oriented liquid crystal molecules prevent the ionic impurities from being re-diffused in the display region due to the concentration gradient in a region, in which the control electrode is provided, between the peripheral electrode and the outer edge of the display region even if the ionic impurities are attracted to the peripheral electrode and the concentration gradient of the ionic impurities occurs between the region in which the peripheral electrode is provided and the display region. That is, since the ionic purities cannot easily be re-diffused from the region in which the peripheral electrode is provided to the display region with elapse of time in the non-display period, it is possible to provide a liquid crystal device with highly reliable display quality.

In the liquid crystal device according to the application example, it is preferable that the common electrode is provided on the other of the pair of substrates so as to face at least the control electrode and the pixel electrode via the liquid crystal layer, that the liquid crystal molecules have negative dielectric anisotropy, and that the orientation film is provided so as to substantially vertically orient the liquid crystal molecules in the liquid crystal layer between the pixel electrode and the common electrode.

With such a configuration, since the ionic impurities cannot easily be re-diffused from the region in which the peripheral electrode is provided to the display region in the non-display period, it is possible to provide a liquid crystal device of a vertical alignment (VA) scheme with highly reliable display quality.

In the liquid crystal device according to the application example, the orientation film may be formed of an inorganic material.

With such a configuration, it is possible to provide a liquid crystal device with a reduced influence of the ionic impurities on display even if the inorganic orientation film that easily adsorbs the ionic impurities are employed.

In the liquid crystal device according to the application example, it is preferable that a width of the control electrode in a direction from an outer edge of the display region toward the sealing material is smaller than a distance between the outer edge of the display region and the control electrode.

With such a configuration, it is possible to suppress occurrence of defects, such as a decrease in contrast, in display in the display region due to a traverse electric field caused between the control electrode and the pixel electrode in the display region in the display period.

In the liquid crystal device according to the application example, it is preferable that a width of the control electrode in a direction from an outer edge of the display region toward the sealing material is smaller than a distance between the peripheral electrode and the control electrode.

With such a configuration, it is possible to suppress a traverse electric field, which is caused between the peripheral electrode and the control electrode in the display period, preventing ionic impurities from being attracted to the peripheral electrode.

In the liquid crystal device according to the application example, it is preferable that a width of the control electrode in a direction from an outer edge of the display region toward the sealing material is greater than a thickness of the liquid crystal layer.

With such a configuration, it is possible to reliably secure the region of the substantially vertically oriented liquid crystal molecules between the control electrode and the common electrode in the non-display period and to thereby more reliably suppress re-diffusion of the ionic impurities, which have been attracted to the peripheral electrode, to the display region in the non-display period.

In the liquid crystal device according to the application example, the peripheral electrode may include a first electrode that is supplied with a first potential, a second electrode that is supplied with a second potential, and a third electrode that is supplied with a third potential, the first electrode, the second electrode, and the third electrode being arranged with a gap in a direction from the outer edge of the display region toward the sealing material, and that AC signals with the same frequency are respectively supplied to the first electrode, the second electrode, and the third electrode such that the second potential shifts from positive polarity or a reference potential to negative polarity after the first potential shifts from the positive polarity or the reference potential to the negative polarity and before the first potential then shifts to the reference potential or the positive polarity, the third potential shifts from the positive polarity or the reference potential to the negative polarity after the second potential shifts to the negative polarity and before the second potential then shifts to the reference potential or the positive polarity, the second potential shifts from the negative polarity or the reference potential to the positive polarity after the first potential shifts from the negative polarity or the reference potential to the positive polarity and before the first potential then shifts to the reference potential or the negative polarity, and the third potential shifts from the negative polarity or the reference potential to the positive polarity after the second potential shifts from the negative polarity or the reference potential to the positive polarity and before the second potential then shifts to the reference potential or the negative polarity.

With such a configuration, AC signals with deviated phases are supplied to the first electrode, the second electrode, and the third electrode in this order in a period of time corresponding to one cycle during which the first potential shifts from the reference potential to the positive polarity and the negative polarity. Therefore, a direction of an electric field (line of electric force) caused between these electrodes moves from the first electrode that is located at a close position to the display region to the second electrode and from the second electrode to the third electrode with elapse of time. The ionic impurities are attracted to the first electrode first and are then attracted to the second electrode and the third electrode along with the movement in the direction of the electric field. That is, it is possible to provide a liquid crystal device, which is capable of effectively sweep the ionic impurities in the liquid crystal layer from the display region to the outside in the display period, in which the ionic impurities cannot easily be re-diffused to the display region in the non-display period.

In the liquid crystal device according to the application example, a dummy pixel electrode arranged inside the display region may be further included along the outer edge of the display region, and the same potential as that of the common electrode may be supplied to the dummy pixel electrode in the display period during which the pixel electrode is driven.

With such a configuration, the dummy pixel electrode is included between the control electrode and the effective pixel electrode in the display region, and occurrence of the traverse electric field between the control electrode and the effective pixel electrode is suppressed. Therefore, it is possible to suppress the traverse electric field preventing the ionic impurities from being attracted to the peripheral electrode in the display period.

In the liquid crystal device according to the application example, it is preferable that a light blocking layer is provided on the other substrate at a position at which the light blocking layer overlaps the peripheral electrode and the control electrode in a plan view.

With such a configuration, it is possible to accumulate the ionic impurities in the region in which the peripheral electrode is provided and to thereby prevent an influence of disturbed orientation of the liquid crystal molecules and occurrence of light leakage on a display state in the display region by the light blocking layer blocking the light leakage.

### Application Example

According to this application example, there is provided a method of driving a liquid crystal device including a liquid crystal layer that is interposed between a pair of substrates arranged so as to face each other via a sealing material, pixel electrode that is provided on one of the pair of substrates, a peripheral electrode that is arranged between an outer edge of a display region in which the pixel electrode is arranged and the sealing material, a control electrode that is arranged between the outer edge of the display region and the peripheral electrode, a common electrode that is provided on any of the pair of substrates, and orientation film that substantially vertically orients liquid crystal molecules in the liquid crystal layer on the control electrode, the method including: applying an AC potential with reference to a potential of the common electrode or a potential that is lower than the potential of the common electrode to the peripheral electrode in a display period during which the pixel electrode is driven, applying an AC potential with reference to the potential of the common electrode to the control electrode, and not applying a potential to the control electrode in a non-display period during which the pixel electrode is not driven.

According to the application example, the ionic impurities are attracted from the display region toward the peripheral electrode in the display period even if the ionic impurities are included in the liquid crystal layer. Since no potential is applied to the control electrode in the non-display period during which the pixel electrode is not driven, the liquid crystal molecules in the liquid crystal layer on the control electrode are substantially vertically oriented. Therefore, the substantially vertically oriented liquid crystal molecules prevent the ionic impurities from being re-diffused in the display region due to the concentration gradient in a region, in which the control electrode is provided, between the peripheral electrode and the outer edge of the display region even if the ionic impurities are attracted to the peripheral electrode and the concentration gradient of the ionic impurities occurs between the region in which the peripheral electrode is provided and the display region. That is, since the ionic purities cannot easily be re-diffused from the region in which the peripheral electrode is provided to the display region with elapse of time in the non-display period, it is possible to provide a method of driving a liquid crystal device that is capable of realizing highly reliable display quality.

In the method of driving a liquid crystal device according to the application example, it is preferable that the peripheral electrode includes a first electrode that is supplied with a first potential, a second electrode that is supplied with a second potential, and a third electrode that is supplied with a third potential, the first electrode, the second electrode, and the third electrode being arranged in a direction from the outer edge of the display region toward the sealing material, and that AC signals with the same frequency are respectively applied to the first electrode, the second electrode, and the third electrode such that the second potential shifts from positive polarity or a reference potential to negative polarity after the first potential shifts from the positive polarity or the reference potential to the negative polarity and before the first potential then shifts to the reference potential or the positive polarity, the third potential shifts from the positive polarity or the reference potential to the negative polarity after the second potential shifts to the negative polarity and before the second potential then shifts to the reference potential or the positive polarity, the second potential shifts from the negative polarity or the reference potential to the positive polarity after the first potential shifts from the negative polarity or the reference potential to the positive polarity and before the first potential then shifts to the reference potential or the negative polarity, and the third potential shifts from the negative polarity or the reference potential to the positive polarity after the second potential shifts from the negative polarity or the reference potential to the positive polarity and before the second potential then shifts to the reference potential or the negative polarity.

According to the method, the AC signals with deviated phases are applied to the first electrode, the second electrode, and the third electrode in this order in a period of time corresponding to one cycle during which the first potential shifts from the reference potential to the positive polarity and the negative polarity. Therefore, a direction of an electric field (line of electric force) caused between these electrodes moves from the first electrode that is located at a close position to the display region to the second electrode and from the second electrode to the third electrode with elapse of time. The ionic impurities are attracted to the first electrode first and are then attracted to the second electrode and the third electrode along with the movement in the direction of the electric field. That is, it is possible to provide a method of driving a liquid crystal device, which is capable of effectively sweep the ionic impurities in the liquid crystal layer from the display region to the outside in the display period, in which the ionic impurities cannot easily be re-diffused to the display region in the non-display period.

In the method of driving a liquid crystal device according to the application example, the liquid crystal device may include a dummy pixel electrode arranged inside the display region along an outer edge of the display region, and that in the display period during which the pixel electrode is driven, the same potential as that of the common electrode may be applied to the dummy pixel electrode.

According to the method, the same potential as that of the common electrode is applied to the dummy pixel electrode between the control electrode and the effective pixel electrode in the display region in the display period. Therefore, occurrence of a traverse electric field between the control electrode and the effective pixel electrode is suppressed. Accordingly, it is possible to suppress the traverse electric field preventing the ion impurities from being attracted to the peripheral electrode in the display period.

### Application Example

According to this application example, there is provided an electronic apparatus including the liquid crystal device described in the aforementioned application examples.

According to the application example, it is possible to provide an electronic apparatus with highly reliable display quality.

### BRIEF DESCRIPTION OF THE DRAWINGS

The invention will be described with reference to the accompanying drawings, wherein like numbers reference like elements.

FIG. 1A is a plan view schematically showing a configuration of a liquid crystal device according to a first embodiment, and FIG. 1B is a schematic sectional view taken along the line IB-IB in FIG. 1A.

FIG. 2 is an equivalent circuit diagram showing an electrical configuration of the liquid crystal device according to the first embodiment.

FIG. 3 is a sectional view schematically showing a structure of pixels in the liquid crystal device according to the first embodiment.

FIG. 4 is a plan view schematically showing a relationship between an oblique deposition direction of an inorganic material and a display defect caused by ionic impurities.

FIGS. 5A and 5B are plan views schematically showing a configuration of an ion trap mechanism according to the first embodiment.

FIGS. 6A and 6B are sectional views schematically illustrating an action of the ion trap mechanism according to the first embodiment.

FIG. 7 is a timing chart showing waveforms of signals applied to a peripheral electrode and a control electrode in the ion trap mechanism according to the first embodiment.

FIGS. 8A and 8B are plan views schematically showing a configuration of an ion trap mechanism according to a second embodiment.

FIGS. 9A and 9B are sectional views schematically illustrating the ion trap mechanism according to the second embodiment.

FIG. 10 is a timing chart showing waveforms of signals applied to a peripheral electrode, a control electrode, and a dummy pixel electrode in the ion trap mechanism according to the second embodiment.

FIGS. 11A and 11B are plan views schematically showing a configuration of an ion trap mechanism according to a third embodiment.

FIGS. 12A and 12B are sectional views schematically illustrating an action of the ion trap mechanism according to the third embodiment.

FIG. 13 is a timing chart showing waveforms of signals applied to a peripheral electrode, a control electrode, and a dummy pixel electrode in the ion trap mechanism according to the third embodiment.

FIG. 14 is a plan view schematically showing a configuration of an ion trap mechanism in a liquid crystal device according to a fourth embodiment.

FIGS. 15A and 15B are sectional views schematically illustrating an action of the ion trap mechanism according to the fourth embodiment.

FIG. 16 is a diagram schematically showing a configuration of a projection-type display apparatus as an electronic apparatus according to a fifth embodiment.

### DESCRIPTION OF EXEMPLARY EMBODIMENTS

Hereinafter, a description will be given of embodiments of realizing the invention with reference to drawings. The drawings used are appropriately displayed in an enlarged or contracted manner such that components to be described are recognizable.

An active matrix-type liquid crystal device provided with thin film transistors (TFTs) as pixel switching elements will be exemplified and described in this embodiment. The liquid crystal device can be suitably used as a light modulation section (liquid crystal light valve) in a projection-type display apparatus (liquid crystal projector) which will be described later in detail, for example.

### First Embodiment

### Liquid Crystal Device

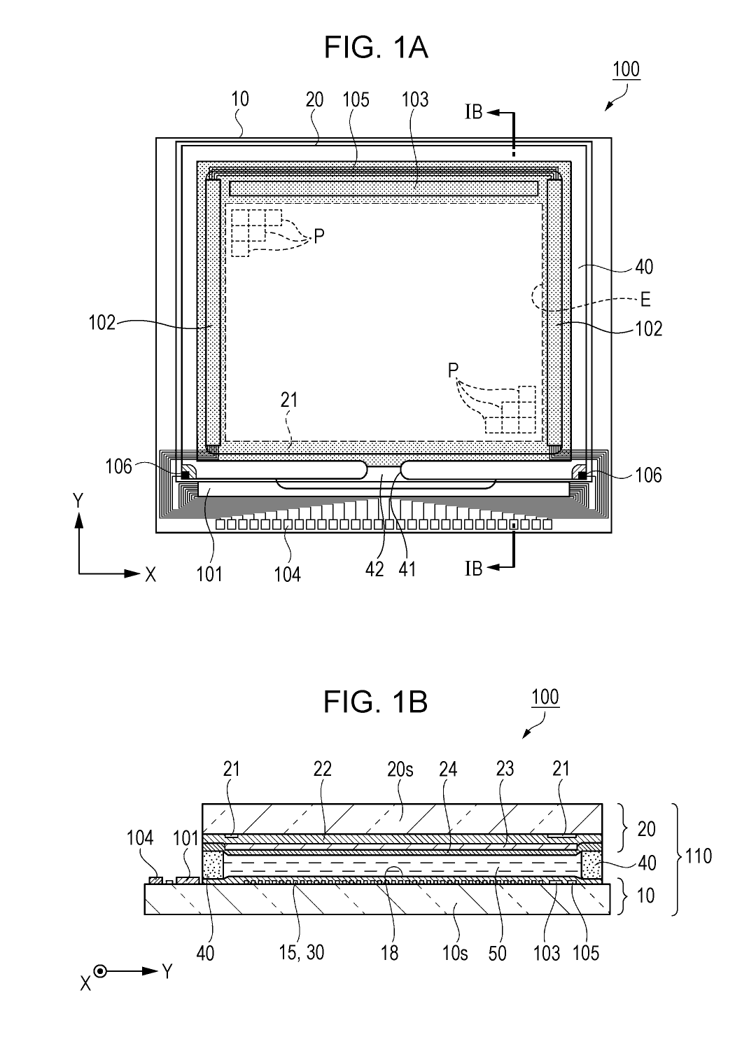

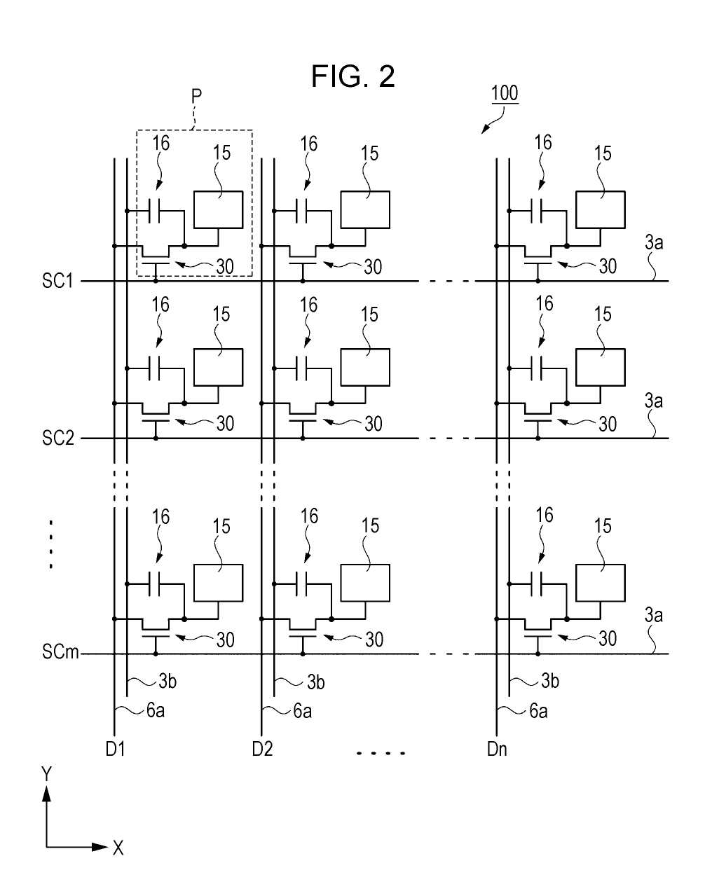

First, a description will be given of the liquid crystal device according to the embodiment with reference to FIGS. 1A to 2. FIG. 1A is a plan view schematically showing a configuration of the liquid crystal device according to the first embodiment, FIG. 1B is a schematic sectional view taken along the line IB-IB in FIG. 1A. FIG. 2 is an equivalent circuit diagram showing an electrical configuration of the liquid crystal device according to the first embodiment.

As shown in FIGS. 1A and 1B, a liquid crystal device 100 according to the embodiment includes an element substrate 10 and a facing substrate 20 that are arranged so as to face each other and a liquid crystal layer 50 that is interposed between the pair of substrates. As a base material 10s of the element substrate 10 and a base material 20s of the facing substrate 20, transparent quartz substrates or glass substrates, for example, are used. The element substrate 10 corresponds to one of the substrates according to the invention, and the facing substrate 20 corresponds to the other of the substrates according to the invention.

The element substrate 10 is greater than the facing substrate 20, and both the substrates are attached to each other at a gap via a sealing material 40 that is arranged along an outer edge of the facing substrate 20. A portion at which the sealing material 40 discontinues corresponds to an injection port 41, liquid crystal with positive or negative dielectric anisotropy is injected into the aforementioned gap from the injection port 41 by a vacuum injection method, and the injection port 41 is encapsulated by using the shielding material 42. A method of encapsulating the liquid crystal in the gap is not limited to the vacuum injection method, and for example, a one-drop fill (ODF) method in which liquid crystal is dropped into the inside of the sealing material 40 arranged in a frame shape and the element substrate 10 and the facing substrate 20 are attached to each other under a reduced pressure may be employed.

As the sealing material 40, an adhesive such as thermosetting or ultraviolet curable epoxy resin is employed, for example. A spacer (not shown) for constantly maintaining the gap between the pair of substrates is mixed into the sealing material 40.

A display region E including a plurality of pixels P aligned in a matrix shape is provided inside the sealing material 40. In addition, a parting section 21 as a light blocking layer is provided between the sealing material 40 and the display region E so as to surround the display region E. The parting section 21 is made of a light-blocking metal or metal oxide, for example.

The element substrate 10 is provided with a terminal section in which a plurality of terminals 104 for external connection are aligned. A data line driving circuit 101 is provided between a first side along the terminal section and the sealing material 40. In addition, an inspection circuit 103 is provided between the sealing material 40 along a second side that faces the first side and the display region E. Furthermore, scanning line driving circuits 102 are provided between the sealing material 40 along third and fourth sides that perpendicularly intersect the first side and face each other and the display region E. A plurality of wirings 105 that connects the two scanning line driving circuits 102 are provided between the sealing material 40 along the second side and the inspection circuit 103.

The wirings that are connected to the data line driving circuit 101 and the scanning line driving circuits 102 are connected to the plurality of terminals 104 for external connection that are aligned along the first side. In addition, the arrangement of the inspection circuit 103 is not limited thereto, and the inspection circuit 103 may be provided at a position along the inside of the sealing material 40 between the data line driving circuit 101 and the display region E.

Hereinafter, a description will be given on the assumption that the direction along the first side is an X direction and the direction along the third side is a Y axis. In addition, viewing in a direction from the side of the facing substrate 20 toward the side of the element substrate 10 will be referred using expressions such as “plan view” and “in a plane”.

As shown in FIG. 1B, light transmitting pixel electrodes 15 and thin film transistors (hereinafter, referred to as TFTs) 30 as switching elements that are provided for the respective pixels P, signal wirings, and an orientation film 18 that covers these components are formed on the surface of the element substrate 10 on the side of the liquid crystal layer 50. In addition, a light blocking structure that prevents light from being incident on a semiconductor layers in the TFTs 30 and prevents a switching operation from being unstable is employed. The element substrate 10 includes the base material 10s, and the pixel electrodes 15, the TFTs 30, the signal wirings, and the orientation film 18 that are formed on the base material 10s.

The facing substrate 20 that is arranged so as to face the element substrate 10 includes a base material 20s, a parting section 21 that is formed on the base material 20s, a flattening layer 22 that is formed as a film covering the parting section 21, a common electrode 23 that covers the flattening layer 22 and is provided at least over the display region E, and an orientation film 24 that covers the common electrode 23.

The parting section 21 is provided at a position at which the parting section 21 surrounds the display region E as shown in FIG. 1A and overlaps the scanning line driving circuit 102 and the inspection circuit 103 in a plane. In doing so, the parting section 21 plays a role in blocking light that is incident on these circuits from the side of the facing substrate 20 and preventing these circuits from erroneously operating due to the light. In addition, the parting section blocks unnecessary stray light from being incident on the display region E and secures high contrast display in the display region E.

The flattening layer 22 is made of an inorganic material such as silicon oxide, has a light transmitting property, and is provided so as to cover the parting section 21. As a method of forming such a flattening layer 22, a method of forming the film by using a plasma CVD method is exemplified.

The common electrode 23 is formed of a transparent conductive film such as indium tin oxide (ITO), covers the flattening layer 22, and is electrically connected to upper and lower conductive sections 106 that are provided at corners of the facing substrate 20 on the lower side as shown in FIG. 1A. The upper and lower conductive sections 106 are electrically connected to wiring on the side of the element substrate 10.

The orientation film 18 that covers the pixel electrodes 15 and the orientation film 24 that covers the common electrode 23 are selected based on optical design of the liquid crystal device 100. As examples of the orientation films 18 and 24, it is possible to exemplify an organic orientation film treated so as to be substantially horizontally oriented with respect to liquid crystal molecules with the positive dielectric anisotropy by forming a film from an organic material such as polyimide and rubbing the surface thereof, and an inorganic orientation film that is substantially vertically oriented with respect to liquid crystal molecules with the negative dielectric anisotropy by forming a film of an inorganic material such as SiOx (silicon oxide) by a vapor phase deposition method.

Such a liquid crystal device 100 is a transmission type and employs optical design of a normally white mode in which transmittance of the pixels P becomes maximum in a voltage non-application state and of a normally black mode in which transmittance of the pixels P becomes minimum in the voltage non-application state. Polarization elements are arranged on a light incident side and light outgoing side of the liquid crystal panel 110, including the element substrate 10 and the facing substrate 20, in accordance with the optical design.

Hereinafter, an example in which the aforementioned inorganic orientation films as the orientation films 18 and 24 and the liquid crystal with the negative dielectric anisotropy are used and the optical design of the normally black mode is applied will be described in this embodiment.

Next, a description will be given of the electrical configuration of the liquid crystal device 100 with reference to FIG. 2. The liquid crystal device 100 includes a plurality of scanning lines 3a and a plurality of data lines 6a, as signal wirings, that are mutually isolated and perpendicularly intersect each other in at least the display region E and capacitance lines 3b that are arranged in parallel with the data lines 6a. A direction in which the scanning lines 3a extend is an X direction, and a direction in which the data lines 6a extend is a Y direction.

The scanning lines 3a, the data lines 6a, and the capacitance lines 3b, and the pixel electrodes 15, the TFTs 30, and the storage capacitors 16 in regions sectioned by the signal lines are provided and configure the pixel circuits of the pixels P.

The scanning lines 3a are electrically connected to gates of the TFTs 30, and the data lines 6a are electrically connected to sources of the TFTs 30. The pixel electrodes 15 are electrically connected to drains of the TFTs 30.

The data lines 6a are connected to the data line driving circuit 101 (see FIGS. 1A and 1B) and supply image signals D1, D2, . . . , Dn, which are supplied from the data line driving circuit 101, to the pixels P. The scanning lines 3a are connected to the scanning line driving circuits 102 (see FIGS. 1A and 1B), and supplies scanning signals SC1, SC2, . . . , SCm, which are supplied from the scanning line driving circuit 102, to the pixels P.

The image signals D1 to Dn that are supplied from the data line driving circuit 101 to the data lines 6a may be sequentially supplied in this order, or may be supplied to each group of a plurality of mutually adjacent data lines 6a. The scanning line driving circuits 102 sequentially supply the scanning signals SC1 to SCm to the scanning lines 3a in a pulse-like manner at predetermined timing.

The liquid crystal device 100 is configured such that the image signals D1 to Dn supplied from the data lines 6a are written in the pixel electrodes 15 at predetermined timing by the TFTs 30 as switching elements being turned into an ON state only for a predetermined period of time by the input of the scanning signals SC1 to SCm. In addition, the image signals D1 to Dn at a predetermined level, which are written in the liquid crystal layer 50 via the pixel electrodes 15, are held for a predetermined period of time between the pixel electrodes 15 and the common electrodes 23 that are arranged so as to face the pixel electrodes 15 via the liquid crystal layer 50. A frequency of the image signals D1 to Dn is 60 Hz, for example.

In order to prevent the held image signals D1 to Dn from leaking, the storage capacitors 16 are connected in parallel with the liquid crystal capacitors that are formed between the pixel electrodes 15 and the common electrode 23. The storage capacitors 16 are provided between the drains of the TFTs 30 and the capacitance lines 3b.

The data lines 6a are connected to the inspection circuit 103 illustrated in FIG. 1A, and the inspection circuit 103 is configured so as to be able to check operation failures and the like of the liquid crystal device 100 by detecting the aforementioned image signals in the process of manufacturing the liquid crystal device 100. However, illustration is omitted in the equivalent circuit of FIG. 2.

A peripheral circuit that drives and controls the pixel circuit in the embodiment includes the data line driving circuit 101, the scanning line driving circuits 102, and the inspection circuit 103. In addition, the peripheral circuit may include a sampling circuit that samples the aforementioned image signals and supplies the image signals to the data lines 6a and a pre-charge circuit that supplies pre-charge signals at a predetermined voltage level to the data lines 6a prior to the aforementioned image signals.

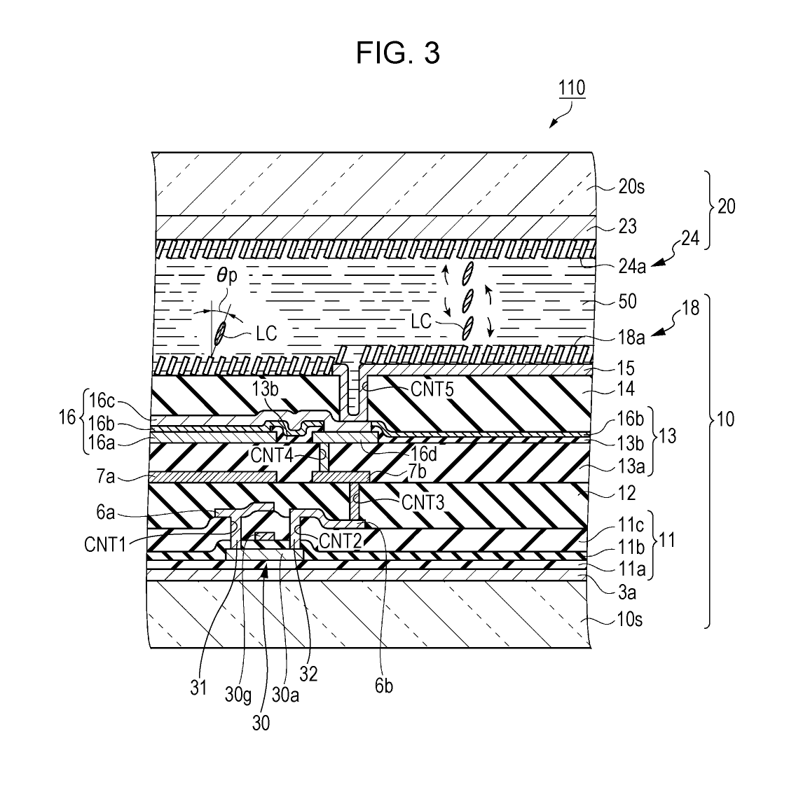

Next, a description will be given of a structure of each pixel P in the liquid crystal device 100 (liquid crystal panel 110) according to the embodiment. FIG. 3 is a sectional view schematically showing a structure of each pixel in the liquid crystal device according to the first embodiment.

As shown in FIG. 3, the scanning lines 3a are formed first on the base material 10s of the element substrate 10. As each scanning line 3a, simple metal including at least one of metal substances such as aluminum (Al), titanium (Ti), chromium (Cr), tungsten (W), tantalum (Ta), and molybdenum (Mo), alloy, metal silicide, nitride, or a laminated body thereof can be used, and the scanning line 3a has a light blocking property.

A first insulating film (base insulating film) 11a made of silicon oxide, for example, is formed so as to cover the scanning line 3a, and a semiconductor layer 30a is formed into an island shape on the first insulating film 11a. The semiconductor layer 30a is made of a polycrystalline silicon film, for example, and a lightly doped drain (LDD) structure including a first source-drain region, a joint region, a channel region, a joint region, and a second source-drain region is formed by injecting impurity ions.

A second insulating film (gate insulating film) 11b is formed so as to cover the semiconductor layer 30a. Furthermore, a gate electrode 30g is formed at a position at which the gate electrode 30g faces the channel region with the second insulating film 11b interposed therebetween.

A third insulating film 11c is formed so as to cover the gate electrode 30g and the second insulating film 11b, and two contact holes CNT1 and CNT2 that penetrate through the second insulating film 11b and the third insulating film 11c are formed at positions at which the contact holes CNT1 and CNT2 overlap the respective ends of the semiconductor layer 30a.

In addition, a conductive film made of a light blocking conductive material, such as aluminum (Al) or alloy thereof, is formed so as to fill the two contact holes CNT1 and CNT2 and cover the third insulating film 11c, and a source electrode 31 and a data line 6a that are connected to the first source-drain region via the contact hole CNT1 are formed by patterning the conductive film. At the same time, a drain electrode 32 (first relay electrode 6b) that is connected to the second source-drain region via the contact hole CNT2 is formed.

Next, a first interlayer insulating film 12 is formed so as to cover the data line 6a, the first relay electrode 6b, and the third insulating film 11c. The first interlayer insulating film 12 is made of oxide or nitride of silicon, for example. Then, flattening processing for flattening surface unevenness, which is caused when a region where each TFT 30 is provided is covered, is performed. As methods of the flattening processing, chemical mechanical polishing (CMP processing) and spin coating processing, for example, are exemplified.

A contact hole CNT3 that penetrates through the first interlayer insulating film 12 is formed at a position at which the contact hole CNT3 overlaps the first relay electrode 6b. A conductive film made of light blocking metal, such as aluminum (Al) or alloy thereof, is formed so as to cover the contact hole CNT3 and the first interlayer insulating film 12, and wiring 7a and a second relay electrode 7b that is electrically connected to the first relay electrode 6b via the contact hole CNT3 are formed by patterning the conductive film. The wiring 7a is formed so as to overlap the semiconductor layer 30a of the TFT 30 and the data line 6a in a plane, is provided with a fixed potential, and is made to function as a shield layer.

A second interlayer insulating film 13a is formed so as to cover the wiring 7a and the second relay electrode 7b. The second interlayer insulating film 13a can also be formed by using oxide, nitride, or oxynitride of silicon, for example.

A contact hole CNT4 is formed at a position, at which the contact hole CNT4 overlaps the second relay electrode 7b, in the second interlayer insulating film 13a. A conductive film made of light blocking metal, such as aluminum (Al) or alloy thereof, is formed so as to cover the contact hole CNT4 and the second interlayer insulating film 13a, and first capacitance electrode 16a and a third relay electrode 16d are formed by patterning the conductive film.

The insulating film 13b is patterned so as to cover an outer edge at a portion, which faces the second capacitance electrode 16c via a dielectric layer 16b that will be formed layer, of the first capacitance electrode 16a. In addition, the insulating film 13b is patterned so as to cover the outer edge of the third relay electrode 16d except for a portion overlapping the contact hole CNT5.

The dielectric layer 16b is formed as a film so as to cover the insulating film 13b and the first capacitance electrode 16a. As the dielectric layer 16b, a silicon nitride film, a single-layered film of hafnium oxide (HfO₂), alumina (Al₂o₃), tantalum oxide (Ta₂O₅), or the like or a multi-layered film obtained by laminating at least two single-layered films thereof may be used. A portion of the dielectric layer 16b, which overlaps the third relay electrode 16d in a plane, is removed by etching, for example. A conductive film made of titanium nitride (TiN), for example, is formed so as to cover the dielectric layer 16b, and a second capacitance electrode 16c that is arranged so as to face the first capacitance electrode 16a and is connected to the third relay electrode 16d is formed by patterning the conductive film. The storage capacitor 16 is configured of the dielectric layer 16b, and the first capacitance electrode 16a and the second capacitance electrode 16c that are arranged so as to face each other with the dielectric layer 16b interposed therebetween.

Next, a third interlayer insulating film 14 that covers the second capacitance electrode 16c and the dielectric layer 16b is formed. The third interlayer insulating film 14 is also made of oxide or nitride of silicon, for example, and is subjected to flattening processing such as CMP processing. A contact hole CNT5 that penetrates through the third interlayer insulating film 14 is formed so as to reach a portion, which is in contact with the third relay electrode 16d, of the second capacitance electrode 16c.

A transparent conductive film (electrode film) of ITO or the like is formed so as to cover the contact hole CNT5 and the third interlayer insulating film 14. The pixel electrode 15 that is electrically connected to the second capacitance electrode 16c and the third relay electrode 16d via the contact hole CNT5 is formed by patterning the transparent conductive film (electrode film).

The second capacitance electrode 16c is electrically connected to the drain electrode 32 of the TFT 30 via the third relay electrode 16d, the contact hole CNT4, the second relay electrode 7b, the contact hole CNT3, and the first relay electrode 6b, and is electrically connected to the pixel electrode 15 via the contact hole CNT5.

The first capacitance electrode 16a is formed so as to be laid across a plurality of pixels P and functions as the capacitance line 3b in the equivalent circuit (see FIG. 2). A fixed potential is provided to the first capacitance electrode 16a. In doing so, it is possible to hold the potential, which is provided to the pixel electrode 15 via the drain electrode 32 of the TFT 30, between the first capacitance electrode 16a and the second capacitance electrode 16c.

As described above, a plurality of wirings are formed on the base material 10s of the element substrate 10, and the wiring layers will be represented by using reference numerals of the insulating films and the interlayer insulating films that insulate the wirings. That is, the first insulating film 11a, the second insulating film 11b, and the third insulating film 11c will collectively be referred to as a wiring layer 11. A representative wiring in the wiring layer 11 is the scanning line 3a. A representative wiring in the wiring layer 12 is the data line 6a. The second interlayer insulating film 13a, the insulating film 13b, and the dielectric layer 16b will collectively be referred to as a wiring layer 13, and a representative wiring is the wiring 7a. Similarly, a representative wiring in the wiring layer 14 is the first capacitance electrode 16a (capacitance line 3b).

The orientation film 18 is formed so as to cover the pixel electrode 15, and the orientation film 24 is formed so as to cover the common electrode 23 of the facing substrate 20 that is arranged so as to face the element substrate 10 via the liquid crystal layer 50. The orientation films 18 and 24 are inorganic orientation films and are formed of groups of columns 18a and 24a that are obtained by obliquely depositing an inorganic material such as silicon oxide in a predetermined direction, for example, and causing the inorganic material to grow in columnar shapes as described above. The liquid crystal molecules LC that have negative dielectric anisotropy against the orientation films 18 and 24 are substantially vertically oriented (vertical alignment: VA) with a pre-tilt angle θp from 3° to 5° in the inclination directions of the columns 18a and 24a with respect to normal line directions of the orientation film planes. The liquid crystal molecules LC behave (oscillate) so as to incline in a direction of an electric field caused between the pixel electrode 15 and the common electrode 23 by applying an AC voltage (drive signal) between the pixel electrode 15 and the common electrode 23 and driving the liquid crystal layer 50.

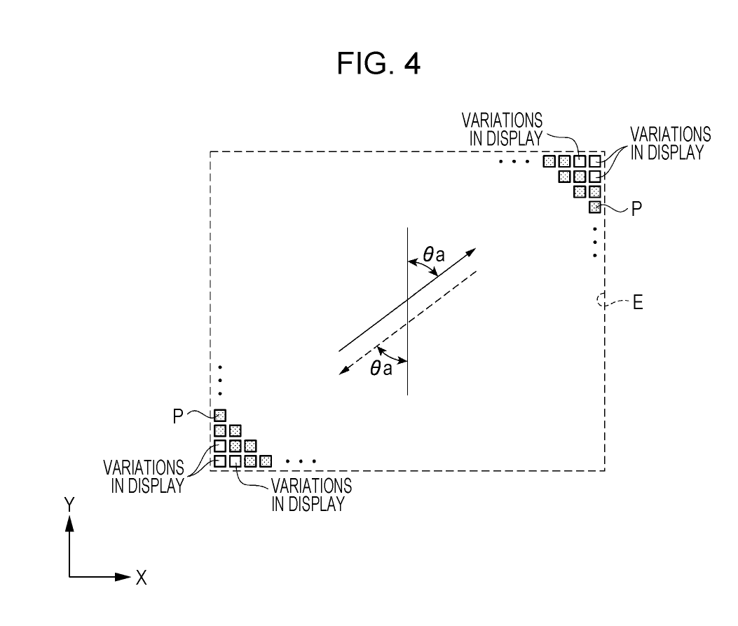

FIG. 4 is a plan view schematically showing a relationship between the oblique deposition direction of the inorganic material and a display defect caused by ionic impurities. The direction of the oblique deposition of the inorganic material for forming the columns 18a and 24a is a direction that intersects the Y direction at a predetermined orientation angle θa from the upper right side toward the lower left side as shown by the arrow of the broken line on the side of the element substrate 10, for example, as shown in FIG. 4. The direction of the oblique deposition thereof is a direction that intersects the Y direction at the predetermined orientation angle θa from the lower left side toward the upper right side as shown by the arrow of the solid line on the side of the facing substrate 20 that is arranged so as to face the element substrate 10. The predetermined angle θa is 45°, for example. The oblique deposition direction shown in FIG. 4 is a direction when the liquid crystal device 100 is viewed from the side of the facing substrate 20.

The behavior (oscillation) of the liquid crystal molecules LC occurs by driving the liquid crystal layer 50, and a flow of the liquid crystal molecules LC occurs in the oblique deposition direction shown by the arrow of the broken line or the solid line in FIG. 4 in the vicinity of interfaces between the liquid crystal layer 50 and the orientation films 18 and 24. If the liquid crystal layer 50 includes ionic impurities with positive or negative polarity, there is a concern that the ionic impurities move toward and are eccentrically located at the corners of the display region E along the flow of the liquid crystal molecules LC. A decrease in insulation resistance of the liquid crystal layer 50 at the pixels P that are located at the corners due to the eccentrically located ionic impurities brings about a decrease in a drive potential at the pixels P, and variations in display as shown in FIG. 4 or an image persistence phenomenon due to energization significantly appears. In a case of using inorganic orientation films as the orientation films 18 and 24, in particular, the variations in display or the image persistence phenomenon appears more outstandingly as compared with organic orientation films since the inorganic orientation films easily adsorb the ionic impurities.

The ionic impurities are considered to be included in members, such as the sealing material 40 and the shielding material 42, that are used in a process of manufacturing the liquid crystal panel 110 or enter from an environment of the process. Since the liquid crystal device 100 according to the embodiment is used as a light modulation section (liquid crystal light valve) in a projection-type display apparatus (liquid crystal projector) which will be described later, intensity of incident illumination light is higher than that of a direct view-type liquid crystal device. There is a concern that terminating groups of the liquid crystal molecules LC, which is an organic compound, come off and become ionic impurities due to illumination light with high intensity being incident on the liquid crystal layer 50. It was discovered from a scientific analysis that ionic impurities with positive polarity (+) rather than ionic impurities with negative polarity (−) cause the aforementioned variations in display and the image persistence phenomenon.

### Ion Trap Mechanism and Method of Driving Liquid Crystal Device

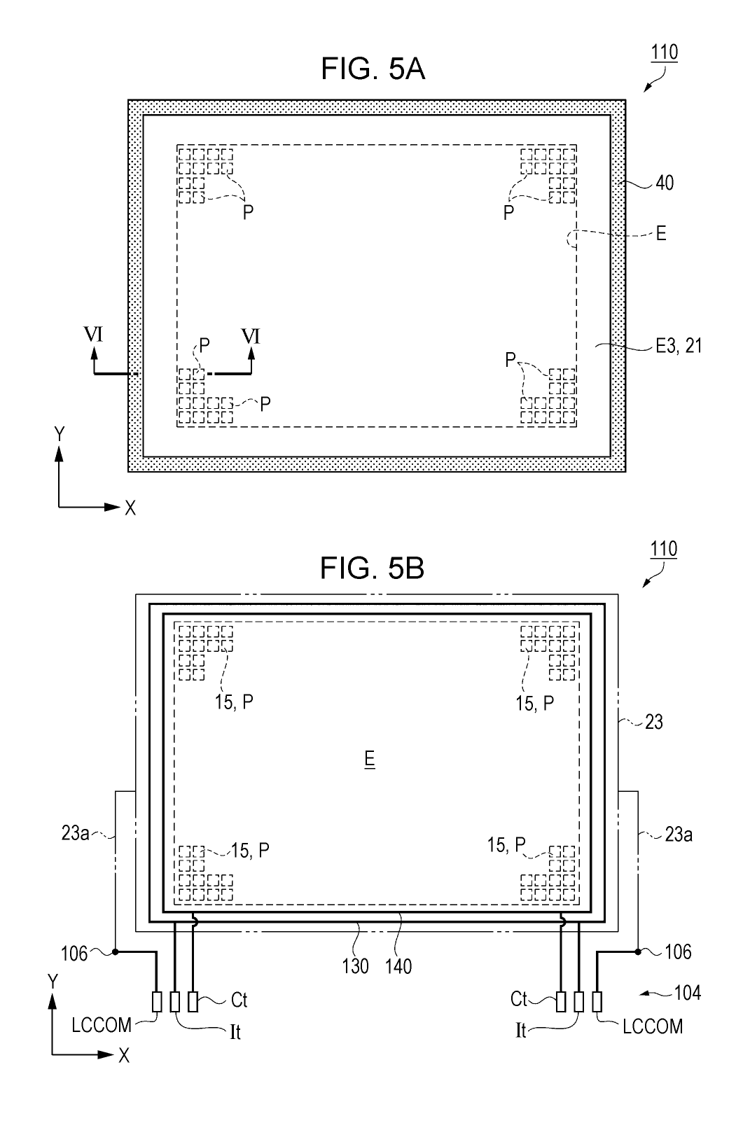

The liquid crystal device 100 according to the embodiment includes an ion trap mechanism for attracting positive (+) ionic impurities from the display region E that is provided between the sealing material 40 and the display region E in order to improve variations in display as shown in FIG. 4 and the image persistence phenomenon. Hereinafter, a description will be given of the ion trap mechanism and a method of driving the liquid crystal device according to the embodiment with reference to FIGS. 5A to 7.

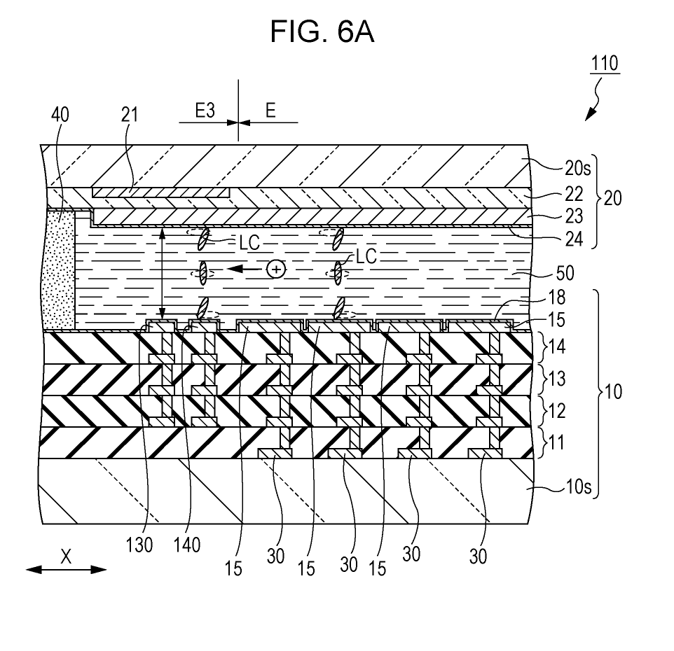

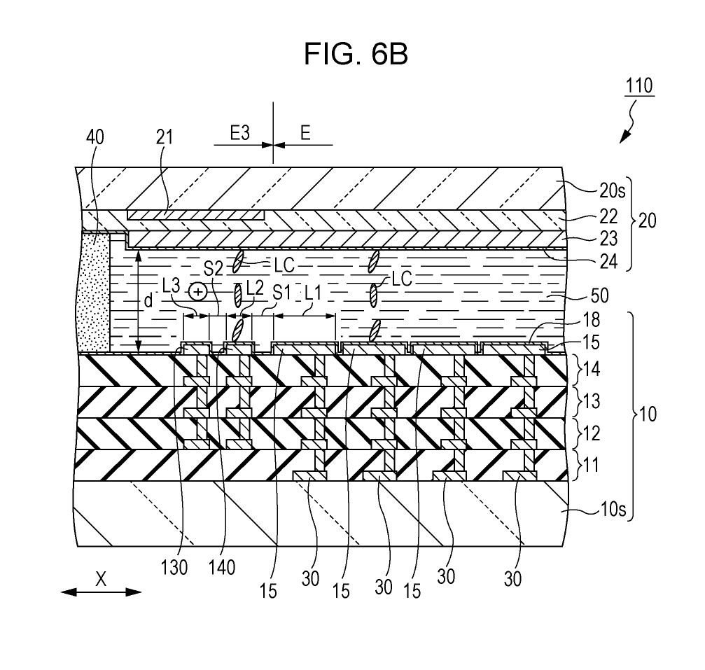

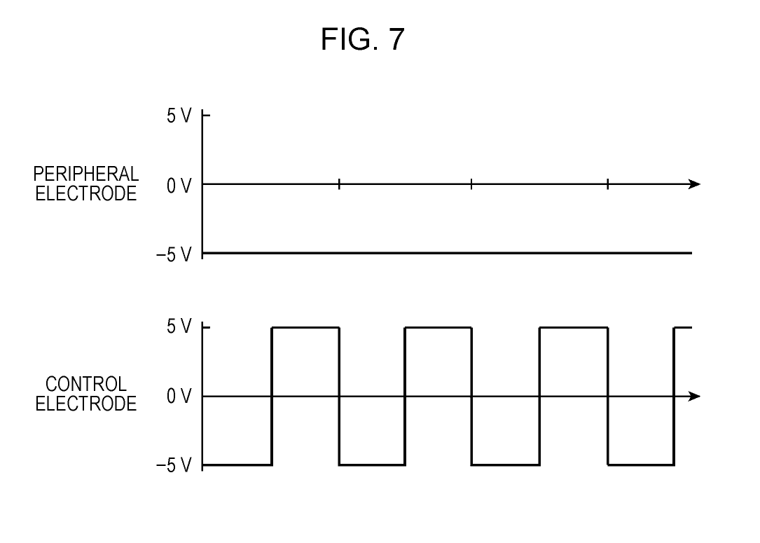

FIGS. 5A and 5B are plan views schematically showing a configuration of the ion trap mechanism according to the first embodiment, and FIGS. 6A and 6B are sectional views schematically illustrating an action of the ion trap mechanism according to the first embodiment (specifically, schematic sectional views taken along the line VI-VI in FIG. 5A). FIG. 7 is a timing chart showing waveforms of signals applied to a peripheral electrode and a control electrode in the ion trap mechanism according to the first embodiment.

As shown in FIG. 5A, the plurality of pixels P are arranged in the X direction and the Y direction in the display region E. The sealing material 40 is arranged so as to surround the display region E. The light blocking parting section 21 is arranged between the display region E and the sealing material 40 as described above. That is, the region between the display region E and the sealing material 40 is a parting region E3.

As shown in FIG. 5B, the ion trap mechanism according to the embodiment includes a peripheral electrode 130 that is provided in a ring shape so as to surround the display region E and a control electrode 140 that is provided between the peripheral electrode 130 and an outer edge of the display region E. The peripheral electrode 130 and the control electrode 140 are provided on the side of the element substrate 10, the peripheral electrode 130 is electrically connected to a terminal 104 (It) for external connection to which a signal for ion trapping is supplied, and the control electrode 140 is electrically connected to a terminal 104 (Ct) for external connection to which a signal for control is supplied.

In the display region E, each of the plurality of pixels P include the pixel electrode 15. The common electrode 23 that is provided on the side of the facing substrate 20 is arranged so as to face the plurality of pixel electrodes 15 in the display region E, the peripheral electrode 130, and the control electrode 140. The common electrode 23 is electrically connected to upper and lower conductive sections 106 via a wiring 23a. The upper and lower conductive sections 106 are electrically connected to a terminal 104 (LCCOM) for external connection to which a fixed potential is supplied.

As described above with reference to FIGS. 3 and 4, the liquid crystal molecules in the liquid crystal layer 50 between the pixel electrodes 15, to which a drive voltage is supplied, and the common electrode 23 shifts from the substantially vertically oriented state to the state in which the liquid crystal molecules LC incline in the direction of the electric field when the drive voltage is supplied to the pixel electrodes 15 and the electric field occurs between the pixel electrodes 15 and the common electrode 23. Since the image signal provided to the pixel electrodes 15 are AC signals with a frequency of 60 Hz, for example, as described above, the behavior (oscillation) of the liquid crystal molecules LC occurs, and the flow of the liquid crystal molecules LC occurs in the vicinity of the interfaces between the liquid crystal layer 50 and the orientation films 18 and 24. Hereinafter, the supply of the image signal (drive voltage) to the pixel electrodes 15 as described above will be referred to drive of the pixel electrodes 15.

In a display period during which the pixel electrodes 15 are driven, an AC potential with reference to the potential (LCCOM) of the common electrode 23 is applied to the control electrode 140. At the same time, a potential that is lower than that of the common electrode 23 is applied to the peripheral electrode 130. Specifically, a rectangular wave with a frequency of 60 Hz, for example, the potential of which varies between 5.0 V and −5.0 V, is applied to the control electrode 140 on the assumption that the potential (LCCOM) of the common electrode 23 is 0 V, for example, as shown in FIG. 7. A DC potential of −5.0 V is applied to the peripheral electrode 130. In the case in which the liquid crystal layer 50 includes the positive (+) ionic impurities, the positive (+) ionic impurities move in the liquid crystal layer 50 along with the behavior (oscillation) of the liquid crystal molecules LC and are attracted to the peripheral electrode 130 with a lower potential than that of the common electrode 23 as shown in FIG. 6A by providing the DC potential to the peripheral electrode 130 in the display period as described above. Since the AC potential is applied to the control electrode 140 at this time and therefore the liquid crystal molecules LC also behave (oscillate) between the control electrode 140 and the common electrode 23, attraction of the positive (+) ionic impurities toward the peripheral electrode 130 is not prevented, or rather the positive (+) ionic impurities are actively directed to the peripheral electrode 130.

In contrast, no potential is applied to the peripheral electrode 130 and the control electrode 140 in the non-display period during which the pixel electrodes 15 are not driven. Therefore, the liquid crystal molecules LC between the side of the pixel electrode 15 and the control electrode 140 and the side of the common electrode 23 are brought into the substantially vertically oriented state as shown in FIG. 6B. Therefore, the liquid crystal molecules LC at a portion corresponding to the control electrode 140 that is adjacent to the peripheral electrode 130 is brought into the substantially vertically oriented state and diffusion of the positive (+) ionic impurities to the side of the display region E is suppressed in the liquid crystal layer 50 in the non-display period even if the positive (+) ionic impurities are attracted to the peripheral electrode 130 and accumulated in the parting section E3 and a concentration gradient occurs between the parting region E3 and the display region E. In addition, the potential (LCCOM) of the common electrode 23 is not limited to 0 V.

From a viewpoint of suppressing the diffusion of the positive (+) ionic impurities, which have been attracted to the peripheral electrode 130, to the side of the display region E in the non-display period, it is preferable that the liquid crystal molecules LC between the control electrode 140 and the common electrode 23 are in a stable substantially vertically oriented state. According to the embodiment, the width L2 of the control electrode 140 in the direction from the outer edge of the display region E (the end of the pixel electrode 15 located at the end of the display region E) toward the sealing material 40 is set to be smaller than the distance S1 between the outer edge of the display region E and the control electrode 140 as shown in FIG. 6B. Specifically, the width L1 of the pixel electrode 15 is 8 μm (micrometer), for example, the distance S1 is 5 μm, for example, and the width L2 of the control electrode 140 is 4 μm, for example.

In addition, the width L2 of the control electrode 140 in the direction from the outer edge of the display region E toward the sealing material 40 is set to be smaller than the distance S2 between the peripheral electrode 130 and the control electrode 140. Specifically, the width L2 of the control electrode 140 is 4 μm, for example, and the distance S2 is 5 μm, for example, as described above. In addition, the width L3 of the peripheral electrode 130 is 4 μm, for example.

Furthermore, the width L2 of the control electrode 140 in a direction from the outer edge of the display region E toward the sealing material 40 is set to be greater than the thickness d of the liquid crystal layer 50.

Specifically, as described above, the width L2 of the control electrode 140 is 4 μm, for example, and the thickness d of the liquid crystal layer 50 is from 1.5 μm to 3.0 μm, for example.

It is possible to realize the stable substantially vertically oriented state of the liquid crystal molecules LC on the control electrode 140 in the non-display period by setting the width L2 of the control electrode 140 as described above. In addition, it is possible to suppress the flow of the liquid crystal molecules LC on the control electrode 140 from being disturbed by a traverse electric field caused between the pixel electrodes 15 and the control electrode 140 and between the control electrode 140 and the peripheral electrode 130 even in the display period.

The orientation film 18 that substantially vertically orients the liquid crystal molecules LC with negative dielectric anisotropy may be formed on the element substrate 10 so as to cover at least the control electrode 140 and the plurality of pixel electrodes 15. In other words, the peripheral electrode 130 may not be covered with the orientation film 18.

According to the liquid crystal device 100 and the driving method thereof of the first embodiment, the following effects can be achieved.

(1) It is possible to attract the positive (+) ionic impurities to the peripheral electrode 130 and to trap the positive (+) ionic impurities at the peripheral electrode 130 in the liquid crystal layer 50 in the display period. In addition, it is possible to suppress re-diffusion of the trapped ionic impurities to the display region E in the non-display period. That is, since the variations in display, the image persistence phenomenon, and the like due to the ionic impurities are improved in the display period and the ionic impurities cannot easily be re-diffused from the parting region E3, in which the peripheral electrode 130 is provide, to the display region E in the non-display period with elapse of time, it is possible to provide the liquid crystal device 100 with highly reliable display quality and the driving method thereof.

(2) Since the parting section 21 as the light blocking layer is arranged so as to overlap the peripheral electrode 130 and the control electrode 140 in the ion trap mechanism in a plan view and the ionic impurities are accumulated in the parting region E3, it is possible to prevent the orientation of the liquid crystal molecules LC from being disturbed, prevent occurrence of light leakage, and prevent an influence on a display state in the display region E by the parting section 21 blocking the light leakage.

### Second Embodiment

### Liquid Crystal Device and Driving Method Thereof

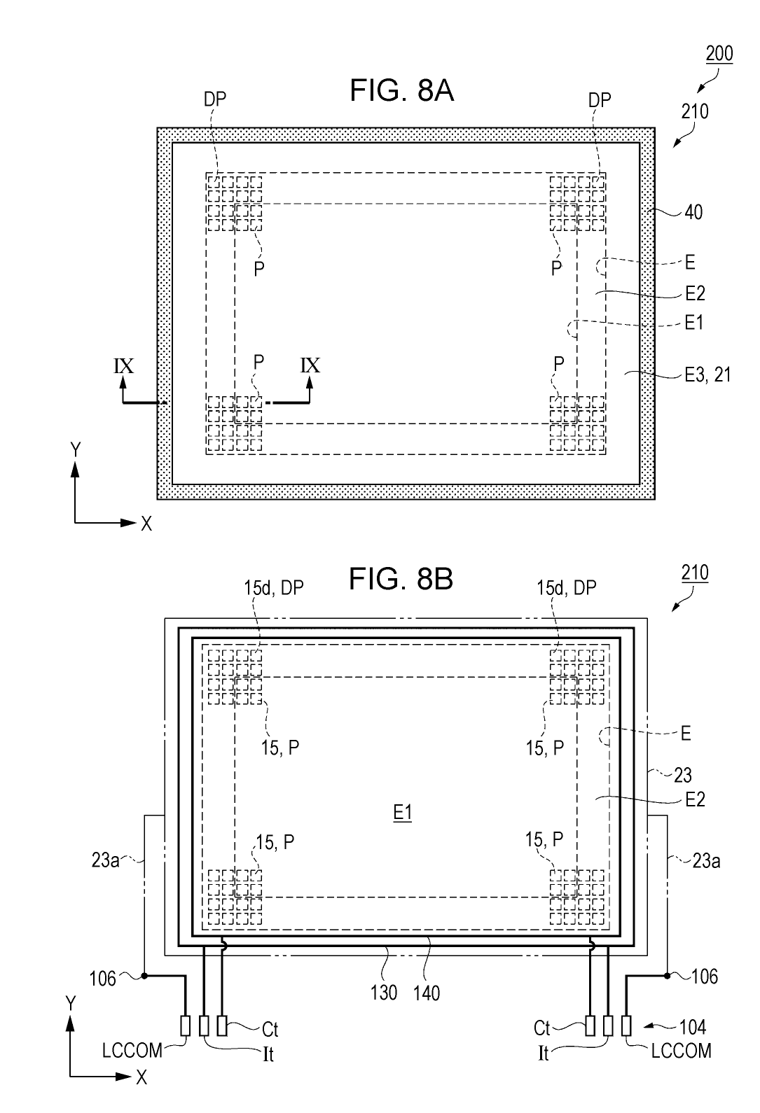

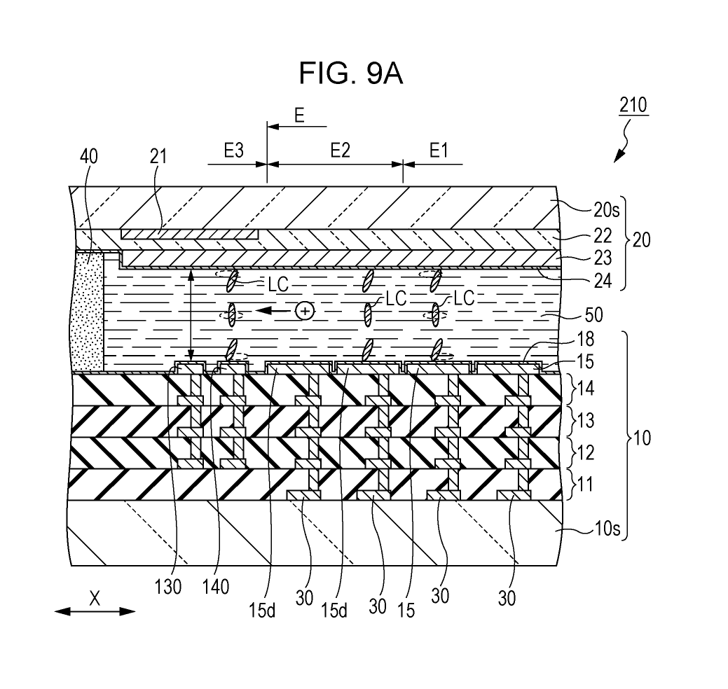

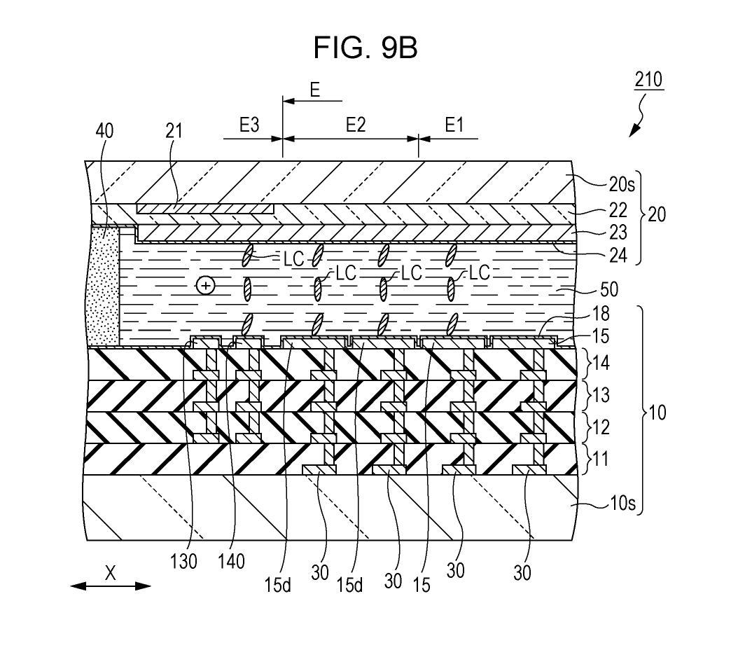

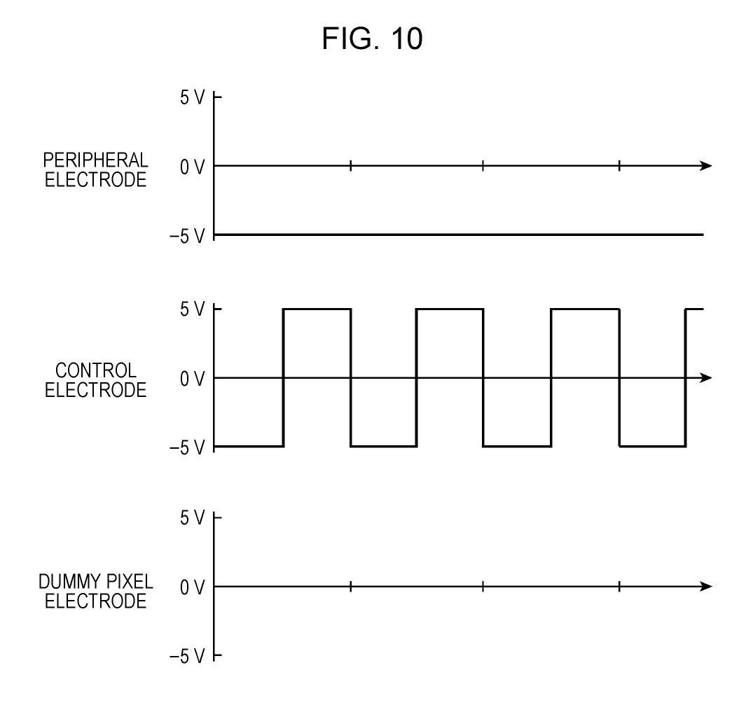

Next, a description will be given of a liquid crystal device and a driving method thereof according to a second embodiment with reference to FIGS. 8A to 10. FIGS. 8A and 8B are plan views schematically showing a configuration of an ion trap mechanism according to the second embodiment, and FIGS. 9A and 9B are sectional views schematically illustrating an action of the ion trap mechanism according to the second embodiment (specifically, schematic sectional views taken along the line IX-IX in FIG. 8A.) FIG. 10 is a timing chart showing waveforms of signals applied to the peripheral electrode, the control electrode, and a dummy pixel electrode in the ion trap mechanism according to the second embodiment.

The liquid crystal device according to the second embodiment is different from the liquid crystal device 100 according to the first embodiment in that the liquid crystal device according to the second embodiment includes dummy pixels in a display region E. Therefore, the same reference numerals will be provided to the same configurations as those in the liquid crystal device 100 according to the first embodiment, and the detailed descriptions thereof will be omitted.

As shown in FIG. 8A, the display region E in a liquid crystal panel 210 of a liquid crystal device 200 according to the embodiment includes an actual display region E1 in which pixels P that contribute to display are arranged and a dummy pixel region E2 including a plurality of dummy pixels DP that are arranged so as to surround the actual display region E1. The light blocking parting section 21 described above is provided between a region in which the sealing material 40 is arranged in a frame shape and the dummy pixel region E2, and a region in which the parting section 21 is provided is a parting region E3 that does not depend on ON and OFF states of the liquid crystal device 200.

In the dummy pixel region E2, two dummy pixels DP are arranged on each of the opposite sides of the actual display region E1 in the X direction, and two dummy pixels DP are arranged on each of the opposite sides of the actual display region E1 in the Y direction. In addition, the number of the dummy pixels DP arranged in the dummy pixel region E2 is not limited thereto, and it is only necessary that at least one dummy pixel DP is arranged on each of the opposite sides of the actual display region E1 in both the X and Y directions. Alternatively, three or more dummy pixels DP may be arranged, or the number of the dummy pixels DP arranged in the X direction may be different from that in the Y direction. According to the embodiment, the dummy pixels DP are made to function as an electronic parting section.

As shown in FIG. 8B, each of the plurality of dummy pixels DP that are arranged so as to surround the actual display region E1 has a dummy pixel electrode 15d. The ion trap mechanism according to the embodiment includes a peripheral electrode 130 that is provided in a ring shape so as to surround the display region E and a control electrode 140 that is provided between the peripheral electrode 130 and the outer edge of the display region E in the same manner as in the first embodiment. The peripheral electrode 130 is electrically connected to a terminal 104 (It) for external connection to which a signal for ion trapping is supplied, and the control electrode 140 is electrically connected to a terminal 104 (Ct) for external connection to which a signal for control is supplied.

The common electrode 23 that is provided on the side of the facing substrate 20 is arranged so as to face the plurality of pixel electrodes 15 and the dummy pixel electrodes 15d in the display region E, the peripheral electrode 130, and the control electrode 140. The common electrode 23 is electrically connected to the upper and lower conductive sections 106 via the wiring 23a. The upper and lower conductive sections 106 are electrically connected to a terminal 104 (LCCOM) for external connection to which a fixed potential is supplied.

As described above in the first embodiment, the behavior (oscillation) of the liquid crystal molecules LC occurs in the liquid crystal layer 50 between the pixel electrodes 15 and the common electrode 23, and the flow of the liquid crystal molecules LC occurs in the vicinity of the interfaces between the liquid crystal layer 50 and the orientation films 18 and 24 by driving the pixel electrodes 15.

According to the method of driving the liquid crystal device 200 of the embodiment, a potential that is lower than the potential of the common electrode 23 is applied to the peripheral electrode 130 in the display period during which the pixel electrodes 15 are driven. At the same time, an AC potential with reference to the potential (LCCOM) of the common electrode 23 is applied to the control electrode 140. Specifically, a DC potential of −5.0 V is applied to the peripheral electrode 130 on the assumption that the potential (LCCOM) of the common electrode 23 is 0 V, for example, as shown in FIG. 10. A rectangular wave with a frequency of 60 Hz, for example, a potential of which varies between 5.0 V and −5.0 V, is applied to the control electrode 140. In doing so, in the case in which the liquid crystal layer 50 includes positive (+) ionic impurities, the positive (+) ionic impurities move in the liquid crystal layer 50 along with the behavior (oscillation) of the liquid crystal molecules LC and are attracted to the peripheral electrode 130 with the lower potential than that of the common electrode 23 as illustrated in FIG. 9A in the display period, as described above in the first embodiment. Since the liquid crystal molecules LC also behave (oscillate) between the control electrode 140 and the common electrode 23, attraction of the positive (+) ionic impurities toward the peripheral electrode 130 is not prevented, or rather the positive (+) ionic impurities are actively directed to the peripheral electrode 130.

In contrast, no potential is applied to the peripheral electrode 130 and the control electrode 140 in the non-display period during which the pixel electrodes 15 are not driven. Therefore, the liquid crystal molecules LC between the side of the pixel electrode 15 and the control electrode 140 and the side of the common electrode 23 are brought into the substantially vertically oriented state as shown in FIG. 9B. Therefore, the liquid crystal molecules LC at a portion corresponding to the control electrode 140 that is adjacent to the peripheral electrode 130 is brought into the substantially vertically oriented state and diffusion of the positive (+) ionic impurities to the side of the display region E is suppressed in the liquid crystal layer 50 in the non-display period even if the positive (+) ionic impurities are attracted to the peripheral electrode 130 and accumulated in the parting section E3 and a concentration gradient occurs between the parting region E3 and the display region E.

According to the embodiment, the dummy pixel electrodes 15d are included between the control electrode 140 and the pixel electrodes 15 as shown in FIGS. 9A and 9B. The same potential as the potential (0 V, for example) of the common electrode 23 is provided to the dummy pixel electrodes 15d as shown in FIG. 10. Therefore, since no electric field occurs between the dummy pixel electrodes 15d and the common electrode 23, the liquid crystal molecules LC are maintained in the substantially vertically oriented state. That is, the dummy pixel region E2 in which the dummy pixels DP including the dummy pixel electrodes 15d are provided displays a block color and functions as the electronic parting section in the display period on the assumption that the optical design of the liquid crystal device 200 according to the embodiment is the normally black mode in the same manner as in the first embodiment. In contrast, an AC potential is provided to the control electrode 140, and an AC potential in accordance with an image signal is provided to the pixel electrodes 15 in the display period. Therefore, since the orientation state of the liquid crystal molecules LC in the dummy pixel region E2 is affected by the behavior (oscillation) of the liquid crystal molecules LC in the parting section E3 in which the adjacent control electrode 140 is provided and in the actual display region E1, attraction of the positive (+) ionic impurities to the peripheral electrode 130 in the display period is not prevented. Since the liquid crystal molecules LC both in the dummy pixel region E2 and in the parting region E3 are brought into the substantially vertically oriented state in the non-display period, diffusion of the positive (+) ionic impurities, which have been attracted to the peripheral electrode 130, to the side of the display region E is further suppressed as compared with the aforementioned first embodiment in which the dummy pixel region E2 is not provided.

The width of the control electrode 140 is set in the same manner as in the first embodiment and is smaller than the distance between the outer edge of the dummy pixel region E2 and the control electrode 140 in a direction from the dummy pixel region E2 toward the sealing material 40.

According to the liquid crystal device 200 and the driving method thereof of the second embodiment, the following effects can be achieved in addition to the effects (1) and (2) of the aforementioned first embodiment.

(3) It is possible to provide the liquid crystal device 200 that is capable of further suppressing diffusion of the positive (+) ionic impurities, which have been attracted to the peripheral electrode 130, to the side of the display region E as compared with the first embodiment in which the dummy pixel region E2 is not provided, and to provide the driving method thereof.

(4) Since the dummy pixel region E2 functions as the electronic parting section, a traverse electric field does not easily occur between the control electrode 140 and effective pixel electrodes 15, and it is possible to reduce an influence of an application of the AC potential to the control electrode 140 in the display period on display.

### Third Embodiment

### Liquid Crystal Device and Driving Method Thereof

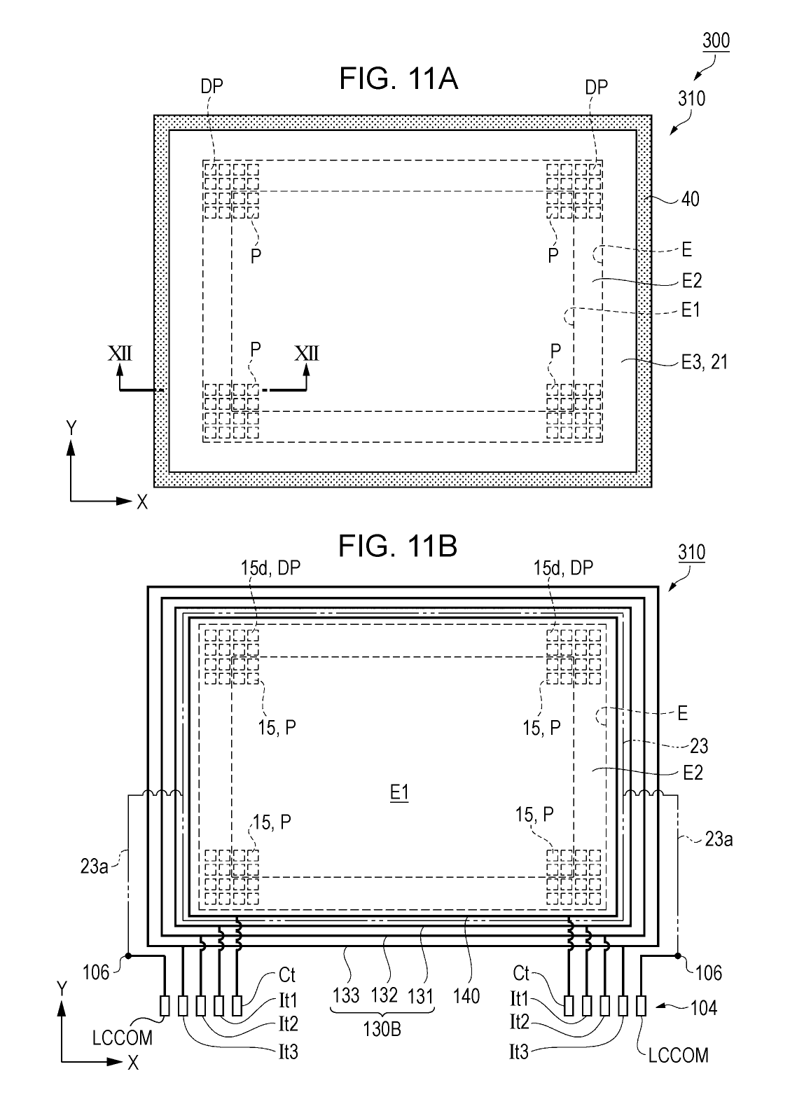

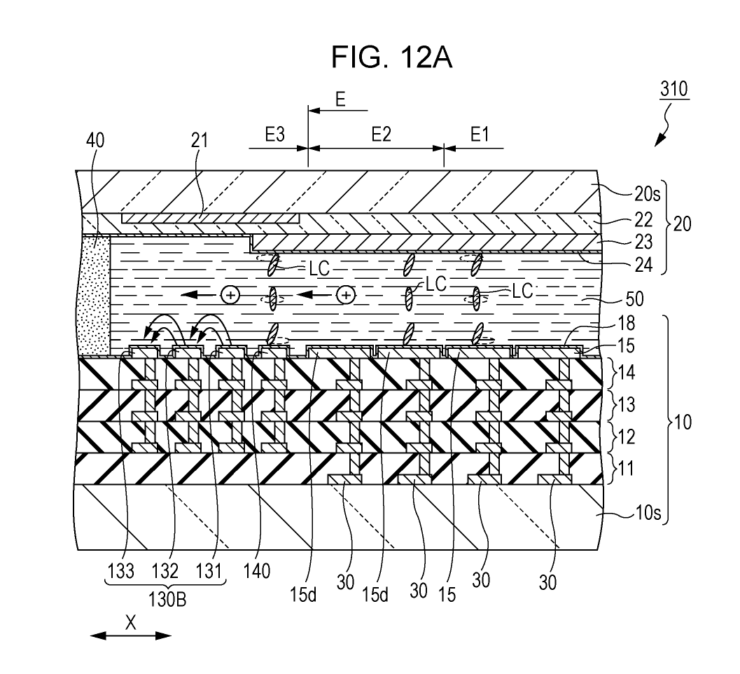

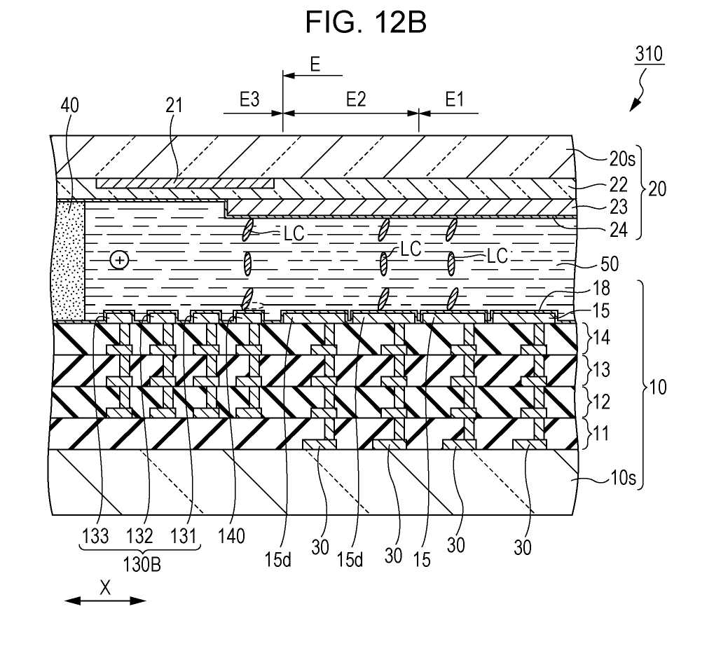

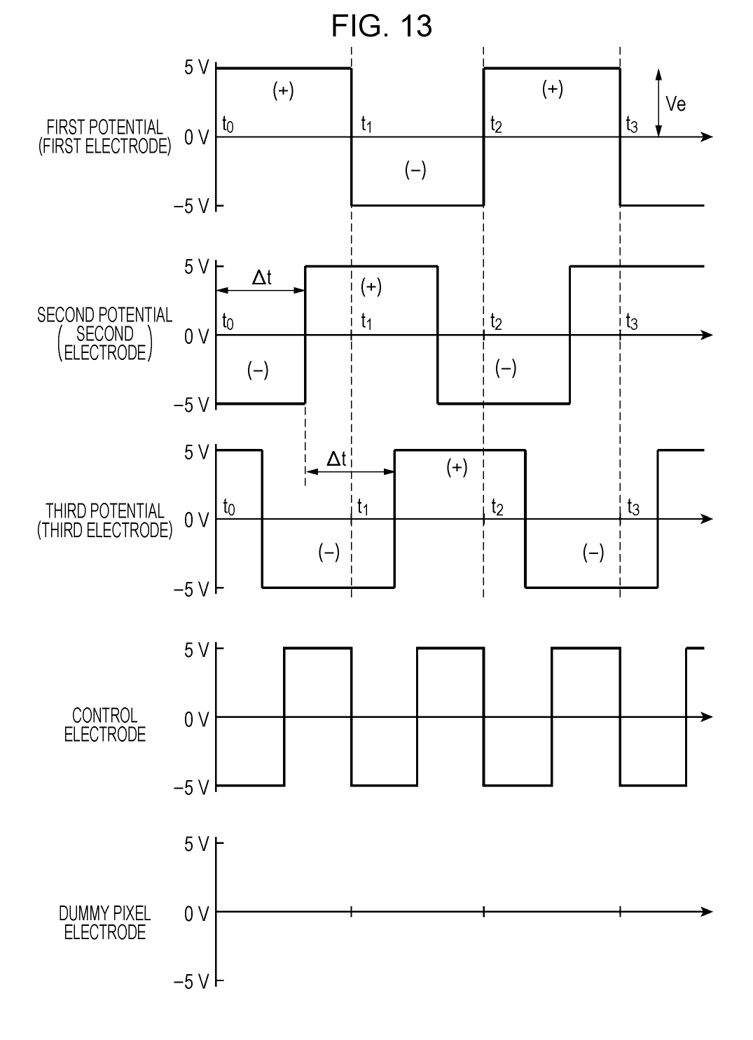

Next, a description will be given of a liquid crystal device and a driving method thereof according to a third embodiment with reference to FIGS. 11A to 13. FIGS. 11A and 11B are plan views schematically showing a configuration of an ion trap mechanism according to the third embodiment, and FIGS. 12A and 12B are sectional views schematically illustrating an action of the ion trap mechanism according to the third embodiment (specifically, a schematic sectional views taken along the line XII-XII in FIG. 11A). FIG. 13 is a timing chart showing waveforms of signals applied to a peripheral electrode, a control electrode, and a dummy pixel electrode in the trap mechanism according to the third embodiment.

The liquid crystal device according to the third embodiment is different from the liquid crystal device 200 according to the second embodiment in a configuration of the peripheral electrode and a driving method thereof. Therefore, the same reference numerals will be given to the same configurations as those in the liquid crystal device 200 according to the aforementioned second embodiment, and detailed descriptions thereof will be omitted.

As shown in FIG. 11A, a display region E in a liquid crystal panel 310 of a liquid crystal device 300 according to the embodiment includes an actual display region E1 in which pixels P that contribute to display are arranged and a dummy pixel region E2 including a plurality of dummy pixels DP that are arranged so as to surround the actual display region E1. A light blocking parting section 21 as described above is provided between a region in which the sealing material 40 is arranged in a frame shape and the dummy pixel region E2, and a region in which the parting section 21 is provided is a parting region E3 that does not depend on ON and OFF states of the liquid crystal device 300. The dummy pixel region E2 according to the embodiment also functions as the electronic parting section in the same manner as in the second embodiment.

As shown in FIG. 11B, each of a plurality of dummy pixels DP that are arranged so as to surround the actual display region E1 has a dummy pixel electrode 15d. The ion trap mechanism according to the embodiment includes a control electrode 140 that is provided in a ring shape so as to surround the display region E and a peripheral electrode 130B. The peripheral electrode 130B according to the embodiment includes a first electrode 131, a second electrode 132, and a third electrode 133 which are electrically independent. The first electrode 131, the second electrode 132, and the third electrode 133 are respectively provided in ring shapes so as to surround the display region E. In addition, the first electrode 131, the second electrode 132, and the third electrode 133 are located at further positions from the display region E in this order. The first electrode 131 is electrically connected to a terminal 104 (It1) for external connection to which a first potential as a signal for ion trapping is supplied. The second electrode 132 is electrically connected to a terminal 104 (It2) for external connection to which a second potential as a signal for ion trapping is supplied. The third electrode 133 is electrically connected to a terminal 104 (It3) for external connection to which a third potential as a signal for ion trapping is supplied. The control electrode 140 is electrically connected to a terminal 104 (Ct) for external connection to which a signal for control is supplied.

The common electrode 23 that is provided on the side of the facing substrate 20 is arranged so as to face the plurality of pixel electrodes 15 and the dummy pixel electrodes 15d in the display region E and the control electrode 140. In other words, the common electrode 23 is arranged so as not to overlap the peripheral electrode 130B in a plan view. The common electrode 23 is electrically connected to the upper and lower conductive sections 106 via the wiring 23a. The upper and lower conductive sections 106 are electrically connected to a terminal 104 (LCCOM) for external connection to which a fixed potential is supplied.

According to the method of driving the liquid crystal device 300 of the embodiment, an AC potential with reference to the potential (LCCOM) of the common electrode 23 is applied to the control electrode 140 in the display period during which the pixel electrodes 15 are driven. The same potential as that of the common electrode 23 is applied to the dummy pixel electrodes 15d. Then, AC signals with the same frequency are applied to the first electrode 131, the second electrode 132, and the third electrode 133 that configure the peripheral electrode 130B such that the second potential shifts from positive polarity or a reference potential to negative polarity after the first potential shifts from the positive polarity or the reference potential to the negative polarity and before the first potential then shifts to the reference potential or the positive polarity, the third potential shifts from the positive polarity or the reference potential to the negative polarity after the second potential shifts to the negative polarity and before the second potential then shifts to the reference potential or the positive polarity, the second potential shifts from the negative polarity or the reference potential to the positive polarity after the first potential shifts from the negative polarity or the reference potential to the positive polarity and before the first potential then shifts to the reference potential or the negative polarity, and the third potential shifts from the negative polarity or the reference potential to the positive polarity after the second potential shifts from the negative polarity or the reference potential to the positive polarity and before the second potential then shifts to the reference potential or the negative polarity.

Specifically, a rectangular wave with a frequency of 60 Hz, for example, a potential of which varies between 5.0 V and −5.0 V, is applied to the control electrode 140 on the assumption that the potential (LCCOM) of the common electrode 23 and the reference potential are 0 V, for example, as shown in FIG. 13. The same potential (0 V, for example) as that of the common electrode 23 is applied to the dummy pixel electrode 15d. Rectangular waves, potentials of which vary between the positive polarity of 5.0 V and the negative polarity of −5.0 V with respect to the reference potential (0 V), are applied to the first electrode 131, the second electrode 132, and the third electrode 133 in one cycle from time t₀ to time t₂. A period from t₀ to t₁ of the positive polarity (+) and a period from t₁ to t₂ of the negative polarity are the same in the rectangular waves. In addition, rectangular waves with phases that are mutually deviated by Δt are applied to the first electrode 131, the second electrode 132, and the third electrode 133. The phase difference Δt of the rectangular waves is ⅓ cycles in the embodiment. Since the rectangular waves with deviated phases are applied to the first electrode 131, the second electrode 132, and the third electrode 133, a traverse electric field between these electrodes shifts (moves) from occurrence between the first electrode 131 and the second electrode 132 to occurrence between the second electrode 132 and the third electrode 133. In contrast, no potential is applied to the peripheral electrode 130B and the control electrode 140 in the non-display period during which the pixel electrodes 15 are not driven.

Therefore, in the case in which the liquid crystal layer 50 includes positive (+) ionic impurities as shown in FIG. 12A, the positive (+) ionic impurities move due to the flow of the liquid crystal molecules LC, are attracted to the parting region E3 in which the peripheral electrode 130B is provided, and are then carried toward the third electrode 133 by the traverse electric field that shifts, in a time-series manner, from the side of the first electrode 131 to the side of the third electrode 133 in the display period during which the pixel electrodes 15 are driven.

In contrast, the positive (+) ionic impurities that have been attracted to the parting region E3 are not easily moved (re-diffused) to the display region E in the non-display period during which the pixel electrodes 15 are not driven since the liquid crystal molecules LC on the control electrode 140 and the dummy pixel electrodes 15d are in the substantially vertically oriented state.

In a case in which the liquid crystal layer 50 includes negative (−) ionic impurities, the negative (−) ionic impurities move due to the flow of the liquid crystal molecules LC and are attracted to the parting region E3 in which the peripheral electrode 130B is provided in the display period, and are not easily moved (re-diffused) to the display region E in the non-display period.

The inventors extracted the frequency f (Hz) of the AC signals, which was preferable for the ion trap mechanism according to the embodiment. In the following description, each electrode of the peripheral electrode 130B, namely each of the first electrode 131, the second electrode 132, and the third electrode 133 will be referred to as an ion trap electrode.

The moving velocity v (m/s (second)) of the ionic impurities in the liquid crystal layer is provided as a product of electric field intensity e (V/m) between adjacent ion trap electrodes and mobility μ (m²/V·s (second)) of the ionic impurities as represented by Equation (1).

That is, v=e×μ (1).

The electric field intensity e (V/m) is a value obtained by dividing a potential difference Vn between the adjacent ion trap electrodes by an arrangement pitch p (m) of the ion trap electrodes as represented by Equation (2).

That is, e=Vn/p (2).

Since the potential difference Vn between the adjacent ion trap electrodes corresponds to the double of the effective voltage Ve of the AC signals, the following equation (3) is obtained.

That is, e=2Ve/p (3).

As illustrated in FIG. 13, the effective voltage Ve of the AC signals of the rectangular waves corresponds to a potential with respect to the reference potential of the rectangular waves and is 5 V in the embodiment.

By substituting Equation (3) into Equation (1), the moving velocity v (m/s) of the ionic impurities is represented by Equation (4).

That is, v=2μVe/p (4).

Time td required for the ionic impurities to move between the adjacent ion trap electrodes is a value obtained by dividing the arrangement pitch p of the adjacent ion trap electrodes by the moving velocity v of the ionic impurities as represented by Equation (5).

That is, td=p/v=p²/2μVe (5).

Therefore, the preferable frequency f (Hz) is obtained by causing the traverse electric field to move in accordance with the time td required for the ionic impurities to move between the adjacent ion trap electrodes. Since the traverse electric field moving time corresponds to the phase difference Δt of the AC signals, the preferable frequency f (Hz) is obtained by the following Equation (6) where the phase difference Δt is assumed to be 1/n cycles. n is the number of ion trap electrodes.

That is, f=1/n/td=2μVe/np² (6).

If the phase difference Δt of the AC signals applied to the adjacent ion trap electrodes is assumed to be ⅓ cycles, for example, as shown in FIG. 13, the potential difference Vn between the adjacent ion trap electrodes in the ion trap mechanism according to the embodiment is 10 V in the case of the AC signals of rectangular waves that shift to 5 V and −5 V with respect to 0 V as the reference potential. If it is assumed that the width of the ion trap electrodes is 4 μm, for example, the arrangement pitch p of the ion trap electrodes is 8 μm, for example, and the mobility μ of the ionic impurities is 2.2×10⁻¹⁰ (m²/V·s), the preferable frequency f is approximately 12 Hz according to Equation (6).

The value of mobility μ of the ionic impurities is described in A. Sawada, A. Manabe, and S. Naemura, “A Comparative Study on the Attributes of Ions in Nematic and Isotropic Phases”, Jpn. J. Appl Phys Vol. 40, p. 220 to p. 224 (2001), for example.

If the frequency f of the AC signals is set to be greater than 12 Hz, the ionic impurities cannot follow the movement of the traverse electric field. Therefore, it is preferable that the frequency f is equal to or smaller than 12 Hz. It is possible to increase the preferable frequency f by setting the arrangement pitch of the ion trap electrodes to be smaller than 8 μm. In addition, it is preferable to set the number of the ion trap electrodes to be greater than three in order to draw the ionic impurities from the display region E to a further location.

When the width of the ion trap electrodes is L and the gap between the ion trap electrodes is S, it is preferable that the width L is equal to or smaller than the gap S. If the width L is greater than the gap S, the time required for the ion impurities to move on ion trap electrodes where the movement of the traverse electric field does not easily occur becomes longer than the time required for the ionic impurities to move between the ion trap electrodes by the movement of the traverse electric field. Therefore, there is a concern that the effect of sweeping the ionic impurities deteriorates.

In addition, the orientation film 18 that substantially vertically orients the liquid crystal molecules LC with negative dielectric anisotropy on the element substrate 10 may be formed so as to cover at least the control electrode 140, the pixel electrodes 15, and the dummy pixel electrodes 15d. In the embodiment, it is preferable that the peripheral electrode 130B is not covered with the orientation film 18 from a viewpoint of causing the traverse electric field between the ion trap electrodes in the peripheral electrode 130B and then moving the ionic impurities.

According to the liquid crystal device 300 and the driving method thereof of the third embodiment, the following effects can be achieved.

(1) The peripheral electrode 130B includes the first electrode 131 to which the first potential is supplied (applied), the second electrode 132 to which the second potential is supplied (applied), and the third electrode 133 to which the third potential is supplied (applied), and the AC signals with the same frequency are supplied (applied) to these electrodes in a state in which the phases of the AC signals are sequentially deviated. Therefore, it is possible to more efficiently attract the ionic impurities to the peripheral electrode 130B and to trap the ionic impurities at the peripheral electrode 130B in the liquid crystal layer 50 in the display period as compared with the aforementioned first and second embodiments. In addition, it is possible to suppress the trapped ionic impurities from being re-diffused to the display region E in the non-display period. That is, it is possible to improve the variations in display, the image persistence phenomenon, and the like due to the ionic impurities in the display period, and the ionic impurities are not easily re-diffused from the parting region E3, in which the peripheral electrode 130B is provided, to the display region E with elapse of time in the non-display period. Therefore, it is possible to provide the liquid crystal device 300 with highly reliable display quality and the driving method thereof.

(2) Since the light blocking parting section 21 is arranged so as to overlap the peripheral electrode 130B in the ion trap mechanism and the control electrode 140 in a plan view and the ionic impurities are accumulated in the parting region E3, it is possible to prevent the orientation of the liquid crystal molecules LC from being disturbed, prevent occurrence of light leakage, and prevent an influence on a display state in the display region E by the parting section 21 blocking the light leakage.

(3) It is possible to provide the liquid crystal device 300 that is capable of further suppressing diffusion of the ionic impurities, which have been attracted to the peripheral electrode 130B, to the side of the display region E as compared with the aforementioned first embodiment in which the dummy pixel region E2 is not provided, and to provide the driving method thereof.

(4) Since the dummy pixel region E2 functions as the electronic parting section, the traverse electric field does not easily occur between the control electrode 140 and effective pixel electrodes 15, and it is possible to reduce an influence of an application of the AC potential to the control electrode 140 in the display period on display.

(5) Since the common electrode 23 does not overlap the peripheral electrode 130B in a plan view, the temporal movement of the traverse electric field from the first electrode 131 to the third electrode 133 in the peripheral electrode 130B (movement in the direction of the electric field) is not affected by the potential of the common electrode 23.

### Fourth Embodiment

### Liquid Crystal Device and Driving Method Thereof

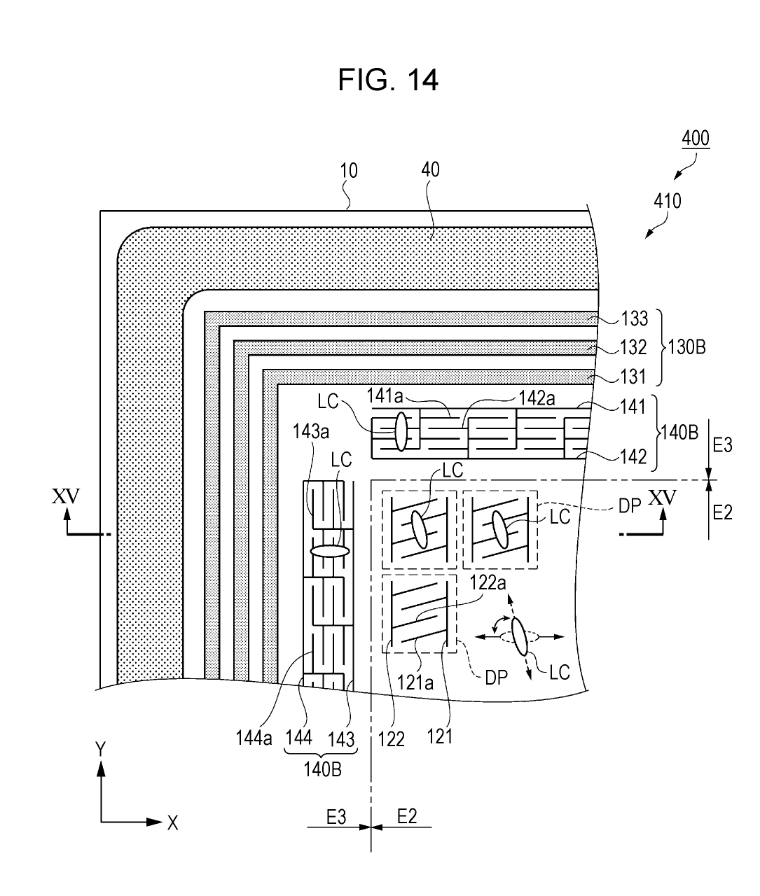

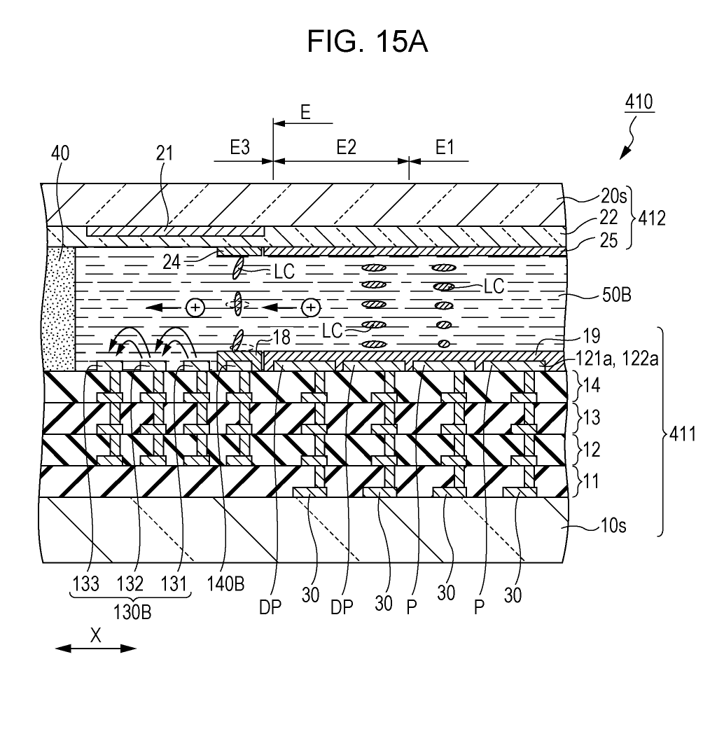

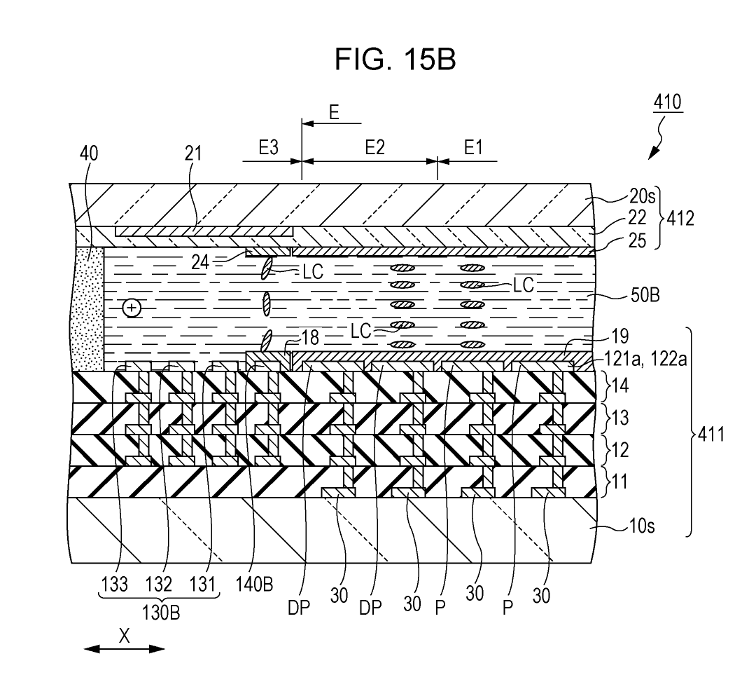

Next, a description will be given of a liquid crystal device and a driving method thereof according to a fourth embodiment with reference to FIGS. 14 to 15B. FIG. 14 is a plan view schematically showing a configuration of an ion trap mechanism in the liquid crystal device according to the fourth embodiment, and FIGS. 15A and 15B are sectional views schematically illustrating an action of the ion trap mechanism according to the fourth embodiment. Specifically, FIGS. 15A and 15B are schematic sectional views taken along the line XV-XV in FIG. 14.

The liquid crystal device according to the fourth embodiment is different from the liquid crystal device 300 according to the aforementioned third embodiment in configurations of the pixel electrodes 15, the dummy pixel electrodes 15d, and the control electrode 140. Therefore, the same reference numerals will be provided to the same configurations as those in the liquid crystal device 300 according to the third embodiment, and the detailed descriptions thereof will be omitted.

As shown in FIG. 14, a liquid crystal device 400 according to the embodiment includes a liquid crystal panel 410. In the liquid crystal panel 410, a liquid crystal layer 50B (see FIGS. 15A and 15B) are configured of liquid crystal molecules LC with positive dielectric anisotropy. Though not shown in FIG. 14, a plurality of pixels P are arranged in the X direction and the Y direction in an actual display region E1. Similarly, a plurality of dummy pixels DP are arranged in the X direction and the Y direction in a dummy pixel region E2 that surrounds the actual display region E1. The dummy pixels DP have a pair of electrode wirings 121 and 122 that extends in the Y direction. The pair of electrode wirings 121 and 122 is arranged at a gap in the X direction. The electrode wiring 121 has interdigital electrodes 121a, which are inclined within a range from about 5° to about 20°, for example, with respect to the X direction, in the gap. The electrode wiring 122 also has interdigital electrodes 122a, which are inclined in parallel with the interdigital electrodes 121a, in the gap. The plurality of interdigital electrodes 121a and the interdigital electrodes 122a are alternately arranged in the gap. Though not shown in FIG. 14, the electrode configuration for the pixels P is the same as that for the dummy pixels DP.

The liquid crystal molecules LC are substantially horizontally oriented in the X direction, for example, when no electric field acts (initial state). If a drive voltage is supplied to the pair of electrode wirings 121 and 122 to cause a traverse electric field between the interdigital electrodes 121a and the interdigital electrodes 122a, the liquid crystal molecules LC with the positive dielectric anisotropy are aligned in the direction of the generated electric field (a direction inclined with respect to the X direction). That is, if the drive voltage is applied to the pair of electrode wirings 121 and 122 in the liquid crystal layer in the vicinity of the interdigital electrodes 121a and 122a on the side of the element substrate 10, the liquid crystal molecules LC are rotated in the direction of the electric field from the X direction in a plane. Such a configuration of the pixels P that includes the pair of electrode wirings 121 and 122 and the interdigital electrodes 121a and 122a is referred to as an in-plane switching (IPS) scheme. In addition, the configuration of the pair of electrode wirings 121 and 122 and the interdigital electrodes 121a and 122a based on the IPS scheme is not limited thereto.

In a parting region E3 that surrounds the display region E including the actual display region E1 and the dummy pixel region E2, a peripheral electrode 130B and a control electrode 140B are provided. The peripheral electrode 130B includes a first electrode 131, a second electrode 132, and a third electrode 133 in the same manner as in the aforementioned third embodiment. In contrast, the control electrode 140B according to the embodiment has a similar electrode configuration as those of the pixels P and the dummy pixels DP. Specifically, the control electrode 140B includes a pair of electrode wirings 141 and 142 that extends in the X direction along the outer edge of the display region E and a pair of electrode wirings 143 and 144 that similarly extends in the Y direction along the outer edge of the display region E. The pair of electrode wirings 141 and 142 is arranged with a gap in the Y direction. The electrode wiring 141 includes interdigital electrodes 141a, which extend in the X direction, in the gap. The electrode wiring 142 also includes interdigital electrodes 142a, which extend in the X direction, in the gap. The plurality of interdigital electrodes 141a and the interdigital electrodes 142a are alternately arranged in the Y direction in the gap. The other pair of electrode wirings 143 and 144 is arranged with a gap in the X direction. The electrode wiring 143 includes interdigital electrodes 143a, which extend in the Y direction, in the gap. The electrode wiring 144 also includes interdigital electrodes 144a, which extend in the Y direction, in the gap. The plurality of interdigital electrodes 143a and the interdigital electrodes 144a are alternately arranged in the X direction in the gap.

If a drive voltage is supplied to the pair of electrode wirings 141 and 142 and a traverse electrode is made to occur between the interdigital electrodes 141a and the interdigital electrodes 142a, the liquid crystal molecules LC with the positive dielectric anisotropy are aligned in the direction of the generated electric field (Y direction). If a drive voltage is supplied to the pair of electrode wirings 143 and 144 and a traverse electric field is made to occur in the interdigital electrodes 143a and the interdigital electrodes 144a, the liquid crystal molecules LC with the positive dielectric anisotropy are aligned in the direction of the generated electric field (X direction).

Next, a description will be given of processing of orienting the liquid crystal molecules LC in the display region E and the parting region E3 with reference to FIGS. 15A and 15B. As shown in FIGS. 15A and 15B, a portion, which faces the liquid crystal layer 50B on the side of the element substrate 10, of the display region E is covered with an orientation film 19. Similarly, a portion, which faces the liquid crystal layer 50B on the side of the facing substrate 20, of the display region E is covered with an orientation film 25. The orientation films 19 and 25 are made of an organic material such as polyimide resin, and orientation processing is performed thereon in advance such that an initial orientation direction of the respective liquid crystal molecules LC becomes the X direction. The facing substrate 20 according to the embodiment does not include the common electrode 23 described above in the first to third embodiments.

In contrast, the control electrode 140B in the parting region E3 on the side of the element substrate 10 is covered with an orientation film 18. Similarly, a portion, which faces the liquid crystal layer 50B on the side of the facing substrate 20, of the parting region E3 is covered with an orientation film 24. The orientation films 18 and 24 are made of an organic material such as polyimide or an inorganic material such as silicon oxide or aluminum oxide for substantially vertically orienting the liquid crystal molecules LC with the positive dielectric anisotropy. That is, the side, which faces the liquid crystal layer 50B, of the facing substrate 20 is selectively covered with the orientation film 25 that substantially horizontally orients the liquid crystal molecules LC and the orientation film 24 that substantially vertically orients the liquid crystal molecules LC, respectively. In addition, the peripheral electrode 130B is not covered with the orientation films. The parting section 21 on the side of the facing substrate 20 is arranged so as to overlap the peripheral electrode 130B and the control electrode 140B in a plan view.

According to the method of driving the liquid crystal device 400 of the embodiment, a common potential (LCCOM) is applied to one of the pair of electrode wirings 121 and 122 for the pixels P and an image signal with a frequency of 60 Hz, for example, is applied to the other electrode wiring in a display period during which the pixels P are driven. In the dummy pixel region E2, the same common potential (LCCOM) is applied to each of the pair of electrode wirings 121 and 122 for the dummy pixels DP. In addition, the common potential (LCCOM) is applied to one of the pair of electrode wirings 141 and 142 of the control electrode 140B, and an AC potential with reference to the common potential is applied to the other electrode wiring. Specifically, a rectangular wave with potential that varies between 5.0 V and −5.0 V is applied to the other electrode while the common potential is set to 0 V, for example. In addition, AC signals with deviated phases are applied to the first electrode 131, the second electrode 132, and the third electrode 133 in the peripheral electrode 130B in the same manner as in the method of driving the liquid crystal device 300 according to the aforementioned third embodiment.

In doing so, the liquid crystal molecules LC are oriented in the X direction in the vicinity of the facing substrate 20 and are oriented while being inclined in the X direction due to the effect of the electric field in the vicinity of the element substrate 10 in the actual display region E1 as shown in FIG. 15A in the display period. Therefore, the liquid crystal molecules LC behave (oscillate) in a twisted state from the side of the facing substrate 20 toward the side of the element substrate 10 in the liquid crystal layer 50B. In the dummy pixel region E2, the liquid crystal molecules LC are in the substantially horizontally oriented state in the X direction. On the control electrode 140B, the liquid crystal molecules LC that are substantially vertically oriented on the side of the facing substrate 20 behave (oscillate) in a state of being gradually changed into the substantially horizontally oriented state toward the side of the element substrate 10.

In a case in which the liquid crystal layer 50B includes positive (+) ionic impurities, for example, the positive (+) ionic impurities move in the liquid crystal layer 50B by the flow of the liquid crystal molecules LC and are attracted to the peripheral electrode 130B. In addition, negative (−) ionic impurities are also attracted to the peripheral electrode 130B in the same manner.

In the non-display period during which the pixels P and the dummy pixels DP are not driven, no potential is applied to the control electrode 140B. Therefore, the liquid crystal molecules LC are brought into a mono-axial substantially horizontally oriented state in the X direction in the display region E as shown in FIG. 15B, and the liquid crystal molecules LC are bright into a mono-axial substantially vertically oriented state especially on the control electrode 140B in the parting region E3. Therefore, ionic impurities are not easily moved (re-diffused) to the display region E due to presence of the substantially vertically oriented liquid crystal molecules LC on the control electrode 140B even if the ionic impurities are attracted to the peripheral electrode 130B and a concentration gradient occurs between the parting region E3 and the display region E.

According to the liquid crystal device 400 and the driving method thereof of the fourth embodiment, the same effects as the effects (1) to (4) of the aforementioned third embodiment can be achieved. In other words, it is possible to apply the ion trap mechanism that includes the peripheral electrode for trapping the ionic impurities and the control electrode not only the VA-type liquid crystal panel but also the liquid crystal panel that includes the liquid crystal layer 50B configured of the liquid crystal molecules LC with the positive dielectric anisotropy.

In addition, the electric wirings to which the common potential (LCCOM) is applied and the interdigital electrodes that are connected to the electrode wirings function as a common electrode. In other words, the invention is not limited to a configuration in which the common electrode is provided on the side of the facing substrate 20, and the common electrode may be provided on the side of the element substrate 10.

### Fifth Embodiment

### Electronic Apparatus

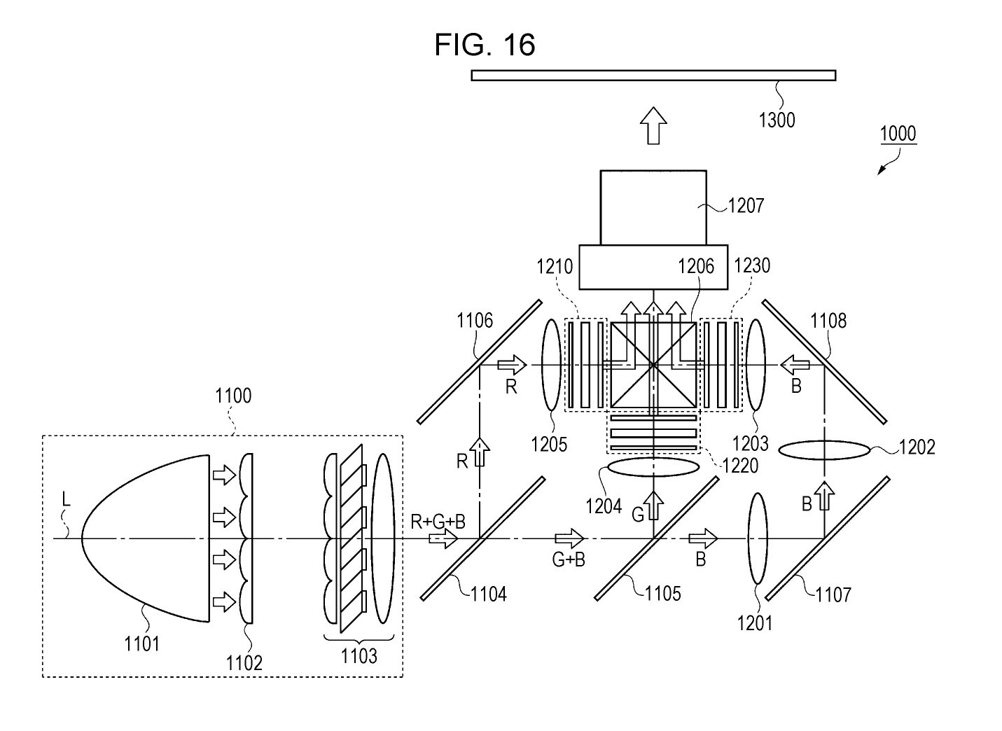

Next, a description will be given of a projection-type display apparatus as an electronic apparatus according to a fifth embodiment with reference to FIG. 16. FIG. 16 is a diagram schematically showing a configuration of the projection-type display apparatus as the electronic apparatus according to the fifth embodiment.

As shown in FIG. 16, the projection-type display apparatus 1000 as the electronic apparatus according to the embodiment includes a polarized illumination device 1100 arranged along a system optical axis L, two dichroic mirrors 1104 and 1105 as optical isolation elements, three reflective mirrors 1106, 1107, and 1108, five relay lenses 1201, 1202, 1203, 1204, and 1205, three transmission-type liquid crystal light valves 1210, 1220, and 1230 as light modulation sections, a cross dichroic prism 1206 as an optical synthesis element, and a projection lens 1207.

The polarized illumination device 1100 is configured to include mainly a lamp unit 1101 as a light source formed of a white light source such as an ultrahigh pressure mercury lamp or a halogen lamp, an integrator lens 1102, and a polarization conversion element 1103.

The dichroic mirror 1104 reflects red light (R) and transmits green light (G) and blue light (B) therethrough from among polarized light fluxes outgoing from the polarized illumination device 1100. The other dichroic mirror 1105 reflects the green light (G) that has been transmitted through the dichroic mirror 1104 and transmits the blue light (B).

The red light (R) reflected by the dichroic mirror 1104 is reflected by the reflective mirror 1106 and is then incident on the liquid crystal light valve 1210 via the relay lens 1205.

The green light (G) reflected by the dichroic mirror 1105 is incident on the liquid crystal light valve 1220 via the relay lens 1204.

The blue light (B) that has been transmitted through the dichroic mirror 1105 is incident on the liquid crystal light valve 1230 via a light guiding system configured of the three relay lenses 1201, 1202, and 1203 and the two reflective mirrors 1107 and 1108.

The liquid crystal light valves 1210, 1220, and 1230 are respectively arranged so as to face the incident surfaces of the cross dichroic prism 1206 for light with each color. The color light that is incident on the liquid crystal light valves 1210, 1220, and 1230 is modulated based on video information (video signal) and is made to outgo toward the cross dichroic prism 1206. The prism is formed such that four right angle prisms are attached and a dielectric body multilayered film that reflects the red light and a dielectric body multilayered film that reflects the blue light are formed into a cross shape in the inner surface thereof. The light with the three colors is synthesized by these dielectric body multilayered films, and light representing a color image is synthesized. The synthesized light is projected onto a screen 1300 by the projection lens 1207 as a projection optical system, and the image is displayed in an enlarged manner.

The liquid crystal light valve 1210 is realized by applying the liquid crystal device 100 according to the first embodiment including the aforementioned ion trap mechanism. A pair of polarization elements arranged in crossed nicols is arranged with a gap on an incident side and an outgoing side of the color light of the liquid crystal panel 110. The other liquid crystal light valves 1220 and 1230 are also configured in the same manner.

Since such a projection-type display apparatus 1000 includes, as the liquid crystal light valves 1210, 1220, and 1230, the liquid crystal device 100 as described above, display defects due to ionic impurities are improved, and it is possible to provide the projection-type display apparatus 1000 with excellent display quality. As the liquid crystal light valves 1210, 1220, and 1230, any of the liquid crystal devices 200, 300, and 400 according to the other embodiments may be used.

The present invention is not limited to the aforementioned embodiments, and appropriate modifications can be made without departing from the gist and the spirit of the invention that can be read from the claims and the entire specification, and the thus modified liquid crystal devices, method of driving the liquid crystal devices, and electronic apparatuses to which the liquid crystal devices are applied are also within the technical scope of the invention. Various modification examples can be considered other than the aforementioned embodiments. Hereinafter, a description will be given of modification examples.

### Modification Example 1

In the respective embodiments, the arrangement of the peripheral electrode and the control electrode is not limited to arrangement of surrounding the display region E. In a case in which a location where a display defect occurs due to eccentrically located ionic impurities is specified as shown in FIG. 4, the peripheral electrode may be arranged in accordance with the location where such a display defect occurs.

### Modification Example 2

In the aforementioned third embodiment, the supply (application) of the AC signals to the first electrode 131, the second electrode 132, and the third electrode 133 in the peripheral electrode 130B is not limited to the supply (application) performed such that the period of the positive polarity with respect to the reference potential is the same as the period of the negative polarity. It is possible to actively attract the positive (+) ionic impurities to the peripheral electrode 130B by setting the period of the negative polarity to be longer than the period of the positive polarity.

### Modification Example 3

Schemes of the liquid crystal device to which the ion trap mechanism according to the aforementioned embodiments can be applied are not limited to the VA scheme and the IPS scheme, and the ion trap mechanism can be applied to a fringe field switching (FFS) scheme and an optically compensated birefringence (OCB) scheme. In addition, the ion trap mechanism can be applied not only to a transmission-type liquid crystal device but also a reflection-type liquid crystal device in which the pixel electrodes 15 are formed by using a light reflective material.

### Modification Example 4

Electronic apparatuses to which the liquid crystal devices 100 to 400 according to the aforementioned embodiments are not limited to the projection-type display apparatus 1000 according to the aforementioned fifth embodiment. For example, the liquid crystal devices 100 to 400 according to the aforementioned embodiment can be suitably used as a display section in an information terminal device such as a projection-type head-up display (HUD), a direct view-type head mount display (HMD), an electronic book, a personal computer, a digital still camera, a liquid crystal television, a view finder-type or monitor direct view-type video recorder, a car navigation system, an electronic personal organizer, or a POS.

The entire disclosure of Japanese Patent Application No. 2015-008355, filed Jan. 20, 2015 is expressly incorporated by reference herein.

What is claimed is:

1. A liquid crystal device comprising:
a liquid crystal layer that is interposed between a pair of substrates arranged so as to face each other via a sealing material;
a pixel electrode that is provided on one of the pair of substrates;
a peripheral electrode that is arranged between an outer edge of a display region in which the pixel electrode is arranged and the sealing material;
a control electrode that is arranged between the outer edge of the display region and the peripheral electrode;
a common electrode that is provided in any one of the pair of substrates; and
an orientation film that substantially vertically orients liquid crystal molecules in the liquid crystal layer on the control electrode,
wherein in a display period during which the pixel electrode is driven, an AC potential with reference to a potential of the common electrode or a potential that is lower than that of the common electrode is supplied to the peripheral electrode, and an AC potential with reference to the potential of the common electrode is supplied to the control electrode, and
wherein in a non-display period during which the pixel electrode is not driven, no potential is supplied to the control electrode.

2. The liquid crystal device according to claim 1,
wherein the common electrode is provided on the other of the pair of substrates so as to face at least the control electrode and the pixel electrode via the liquid crystal layer,
wherein the liquid crystal molecules have negative dielectric anisotropy, and
wherein the orientation film is provided so as to substantially vertically orient the liquid crystal molecules in the liquid crystal layer between the pixel electrode and the common electrode.

3. The liquid crystal device according to claim 1,
wherein the orientation film is formed of an inorganic material.

4. The liquid crystal device according to claim 1,
wherein a width of the control electrode in a direction from an outer edge of the display region toward the sealing material is smaller than a distance between the outer edge of the display region and the control electrode.

5. The liquid crystal device according to claim 1,
wherein a width of the control electrode in a direction from an outer edge of the display region toward the sealing material is smaller than a distance between the peripheral electrode and the control electrode.

6. The liquid crystal device according to claim 1,
wherein a width of the control electrode in a direction from an outer edge of the display region toward the sealing material is greater than a thickness of the liquid crystal layer.

7. The liquid crystal device according to claim 1,
wherein the peripheral electrode includes a first electrode that is supplied with a first potential, a second electrode that is supplied with a second potential, and a third electrode that is supplied with a third potential, the first electrode, the second electrode, and the third electrode being arranged with a gap in a direction from the outer edge of the display region toward the sealing material, and
wherein AC signals with the same frequency are respectively supplied to the first electrode, the second electrode, and the third electrode such that
the second potential shifts from positive polarity or a reference potential to negative polarity after the first potential shifts from the positive polarity or the reference potential to the negative polarity and before the first potential then shifts to the reference potential or the positive polarity,
the third potential shifts from the positive polarity or the reference potential to the negative polarity after the second potential shifts to the negative polarity and before the second potential then shifts to the reference potential or the positive polarity,
the second potential shifts from the negative polarity or the reference potential to the positive polarity after the first potential shifts from the negative polarity or the reference potential to the positive polarity and before the first potential then shifts to the reference potential or the negative polarity, and
the third potential shifts from the negative polarity or the reference potential to the positive polarity after the second potential shifts from the negative polarity or the reference potential to the positive polarity and before the second potential then shifts to the reference potential or the negative polarity.

8. The liquid crystal device according to claim 1, further comprising:
a dummy pixel electrode arranged inside the display region along the outer edge of the display region,
wherein in the display period during which the pixel electrode is driven, the same potential as that of the common electrode is supplied to the dummy pixel electrode.

9. The liquid crystal device according to claim 1,
wherein a light blocking layer is provided on the other substrate at a position at which the light blocking layer overlaps the peripheral electrode and the control electrode in a plan view.

10. A method of driving a liquid crystal device including
a liquid crystal layer that is interposed between a pair of substrates arranged so as to face each other via a sealing material,
a pixel electrode that is provided on one of the pair of substrates,
a peripheral electrode that is arranged between an outer edge of a display region in which the pixel electrode is arranged and the sealing material,
a control electrode that is arranged between the outer edge of the display region and the peripheral electrode,
a common electrode that is provided on any of the pair of substrates, and
an orientation film that substantially vertically orients liquid crystal molecules in the liquid crystal layer on the control electrode,
the method comprising:
applying an AC potential with reference to a potential of the common electrode or a potential that is lower than the potential of the common electrode to the peripheral electrode in a display period during which the pixel electrode is driven, applying an AC potential with reference to the potential of the common electrode to the control electrode, and not applying a potential to the control electrode in a non-display period during which the pixel electrode is not driven.

11. The method of driving a liquid crystal device according to claim 10,
wherein the peripheral electrode includes a first electrode that is supplied with a first potential, a second electrode that is supplied with a second potential, and a third electrode that is supplied with a third potential, the first electrode, the second electrode, and the third electrode being arranged with a gap in a direction from the outer edge of the display region toward the sealing material, and
wherein AC signals with the same frequency are respectively applied to the first electrode, the second electrode, and the third electrode such that
the second potential shifts from positive polarity or a reference potential to negative polarity after the first potential shifts from the positive polarity or the reference potential to the negative polarity and before the first potential then shifts to the reference potential or the positive polarity,
the third potential shifts from the positive polarity or the reference potential to the negative polarity after the second potential shifts to the negative polarity and before the second potential then shifts to the reference potential or the positive polarity,
the second potential shifts from the negative polarity or the reference potential to the positive polarity after the first potential shifts from the negative polarity or the reference potential to the positive polarity and before the first potential then shifts to the reference potential or the negative polarity, and
the third potential shifts from the negative polarity or the reference potential to the positive polarity after the second potential shifts from the negative polarity or the reference potential to the positive polarity and before the second potential then shifts to the reference potential or the negative polarity.

12. The method of driving a liquid crystal device according to claim 10,
wherein the liquid crystal device includes a dummy pixel electrode arranged inside the display region along an outer edge of the display region, and
wherein in the display period during which the pixel electrode is driven, the same potential as that of the common electrode is applied to the dummy pixel electrode.

13. An electronic apparatus comprising:
the liquid crystal device according to claim 1.

14. An electronic apparatus comprising:
the liquid crystal device according to claim 2.

15. An electronic apparatus comprising:
the liquid crystal device according to claim 3.

16. An electronic apparatus comprising:
the liquid crystal device according to claim 4.

17. An electronic apparatus comprising:
the liquid crystal device according to claim 5.

18. An electronic apparatus comprising:
the liquid crystal device according to claim 6.

19. An electronic apparatus comprising:
the liquid crystal device according to claim 7.

20. An electronic apparatus comprising:
the liquid crystal device according to claim 8.
